(19) United States
(12) Patent Application Publication
(10) Pub. No.: US 2012/0063428 A1
(43) Pub. Date: Mar. 15, 2012

(54) Interface Switching System, Mobile Node, Proxy Node, and Mobile Management Node

(75) Inventors: Chan Wah Ng, Singapore (SG); Keigo Aso, Kanagawa (JP); Chun Keong Benjamin Lim, Singapore (SG); Mohana Dhamayanthi Jeyatharan, Singapore (SG)

(73) Assignee: Panasonic Corporation, Kadoma-shi, Osaka (JP)

(21) Appl. No.: 13/122,111

(22) PCT Filed: Oct. 7, 2009
(86) PCT No.: PCT/JP2009/005209

§ 371 Date: Mar. 31, 2011

(30) Foreign Application Priority Data
Oct. 8, 2008 (JP) 2008-261975
Aug. 31, 2009 (JP) 2009-199656

(51) Int. Cl. H04W 84/02

(52) U.S. Cl. 370/338

(57) ABSTRACT

A technology is disclosed for preventing packet and transferring packets to a switched interface with minimal delay, when a mobile node switches a using interface. According to the technology, when a MN 200 is communicating with a MAG (WLAN) 232, a PBU message 301 has already been transmitted from the MAG (WLAN) 232 to the LMA 220, and binding related to a WLAN connection 242 is already registered in the LMA 220. When an interface switching event 300 is generated, the MN 200 transmits to the MAG (WLAN) 232 via the WLAN connection 242, a binding in-advance registration message 302 for registering a binding in advance. When the MAG (WLAN) 232 detects disconnection 310 of the WLAN connection 242, the MAG (WLAN) 232 transmits a registration delete/trigger message 312a to the LMA 220, registers and triggers in the LMA 220 the in-advance registration binding registered in the MAG (WLAN) 232, and deletes the PBU message 301.

### TECHNICAL FIELD

The present invention relates to an interface switching system for switching an interface to be used by a mobile node having a plurality of interfaces.

The present invention also relates to a mobile node, a proxy node, and a mobile management node in the interface switching system.

### BACKGROUND ART

In recent years, a large number of mobile devices have been communicating with one another using internet protocol (IP). To provide the mobile devices with mobility support, the Internet Engineering Task Force (IETF) has proposed “Mobility Support in IPv6” such as that described in Non-patent Document 1, below, and “Network Mobility Support” such as that described in Non-Patent Document 2, below. In mobile IP, each mobile node (including mobile hosts and mobile routers) has a home domain. When a mobile node is attached to its home network, the mobile node is allocated a primary global address known as a home address (HoA). When the mobile node enters an away state, or in other words, attaches to another external network, the mobile node is assigned a temporary global address known as a care-of address (CoA).

Based on the concept of mobility support, the mobile node is reachable at its home address even when attached to an external network. In Non-patent Documents 1 and 2, this reachability is realized by an entity known as a home agent (HA) being introduced to the home network. The mobile node registers the care-of address in the home agent using a message known as a binding update (BU) message. As a result of this registration, the home agent can establish a binding between the home address and the care-of address of the mobile node. The home agent intercepts a message addressed to the home address of the mobile node, encapsulates the packet, and transfers the encapsulated packet to the care-of address of the mobile node. This packet encapsulation is also known as packet tunneling, in which the packet addressed to the home address is set as a payload of a new packet addressed to the care-of address.

In a mobility management method described in Non-patent Document 1, as transfer destination information regarding packets addressed to the mobile host for the home agent of the mobile host, the mobile host notifies the home agent of the binding between an IPv6 CoA and an IPv6 HoA of the mobile host using IPv6 binding update (BU) signaling transmitted via an IPv6-based transport network. In a similar manner, in a mobility management method described in Non-patent Document 2, as transfer destination information regarding packets addressed to the mobile host for the home agent, the home agent is notified of the binding between an IPv6 mobile network prefix of a mobile router and an IPv6 CoA of the mobile router using IPv6 BU signaling via only the IPv6 transport network.

In the future, IPv6 internet service providers (ISP) and IPv6 transport networks will likely become predominant. However, it is unlikely that these IPv6 internet service provider networks and transport provider networks will immediately replace the current IPv4 ISP and IPv4 transport networks. The mobility architecture of the future fourth-generation (4G) mobile phone network in which IPv4 and IPv6 transport networks coexist requires Dual-Stack mobile nodes supporting both IPv4 and IPv6 to realize ubiquitous mobility.

A method described in Non-patent Document 11 mentions Dual Stack Mobile IPv6 (DSMIPv6) that provides client-based IPv6 mobility support for mobile nodes having IPv4 and IPv6 protocol stacks. In the method based on DSMIPv6, the mobile node can establish a binding between its own IPv4/IPv6 home address/prefix and its own IPv4/IPv6 CoA, and register the binding via an IPv4/IPv6 transport network. The DSMIPv6 extends MIPv6 and supports IPv4 clients and IPv4 transport networks. The Third Generation Partnership Project (3GPP) system uses the above-described DSMIPv6 as client-based mobility support. Non-patent document 7 describes various scenarios of when roaming is performed within a 3GPP architecture and when roaming is not performed, using DSMIPv6.

The client-based mobility support described in Non-Patent Document 1, Non-patent Document 2, and Non-patent Document 11 solves the problem of mobility but has a number of problems. One problem is that the mobile node is required to transmit the Binding Update (BU) message to the home agent. Therefore, when the mobile node moves at a high speed, the number of BU messages becomes enormous. Furthermore, when the mobile node is geographically far from the home agent, time is required for the BU message to reach the home agent. Therefore, by the time the home agent starts a packet transfer to the updated care-of address of the mobile node, the mobile node may no longer be positioned in the location of the care-of address.

For this reason, Non-patent Document 3, Non-patent Document 6, Patent Document 7, and Patent Document 8, below, describe proposals that use network-based local mobility management (NetLMM). According to the proposals, the mobile node can continue using the same address even after changing the point of attachment within a local network domain. Therefore, the necessity of frequent transmissions of BU messages from the mobile node to the home agent can be eliminated.

In NetLMM, a single local mobility anchor (LMA), a plurality of mobile access gateways (MAG), and a single Authentication, Authorization, and Accounting (AAA) server are provided. The MAG operates as an access router to which the mobile node attaches. Every time a mobile node attaches to a MAG, the MAG first verifies the credentials of the mobile node by making a query to the AAA server and certifies that the mobile node is qualified to use the services of the local network domain. In a number of implementations, the AAA server also notifies the MAG of a prefix, namely an address, to be allocated to the mobile node. Through this technique, the MAG can advertise to the mobile node, the same prefix known as a Home Network Prefix (HNP). At the same time, the MAG is required to update the LMA such that a packet transmitted to the prefix allocated to the mobile node is tunneled to the appropriate MAG to which the mobile node is attached. This update is actualized by the MAG transmitting to the LMA, a proxy BU (PBU) message that binds the address/prefix used by the mobile node to the address of the MAG.

This technique is also known as proxy mobile IP (PMIPv6) because the MAG transmits the BU message to the LMA as proxy for the mobile node, and the LMA operates as the home agent of the mobile node in the local network domain. Through this technique, because the mobile node references the same Home Network Prefix (HNP) regardless of the MAG to which the mobile node is currently attached, the address does not change. Therefore, the mobile node is not required to frequently transmit BU messages to the home agent.

According to the current trend, a variety of different wireless technologies are being used, and many wireless devices include numerous different access interfaces (such as UMTS cellular interface, Wireless Ethernet (registered trademark) 802.11 interface, WiMAX (registered trademark) 802.16 interface, and Bluetooth (registered trademark) interface). In local mobility management, a plurality of prefixes, or in other words, addresses can be allocated as a method of supporting such devices having a plurality of interfaces. In Non-patent Document 3 and Non-patent Document 6, the mobile node references a different prefix for each interface, and the prefix is retained only while the mobile node is roaming within the same network domain. If the mobile node is a mobile IPv6 node currently roaming an external domain, the mobile node may be required to create a plurality of care-of addresses (one care-of address per prefix) and bind each care-of address with its own home address. This means that, when the mobile node wishes to communicate with the home agent and a Correspondent Node (CN) using all usable interfaces, the mobile node is required to transmit to the home agent and the CN, a plurality of BU messages using, for example, a mechanism such as those shown in Non-patent Document 4 and Non-patent Document 9, below.

Here, as a postulated example of when a plurality of interfaces are used in local mobility management, the mobile node may simultaneously connect a stable interface having a wide communication range (such as a cellular interface) and an unstable interface having a narrow communication range (such as IEEE 802.11 wireless interface). Ordinarily, because the IEEE 802.11 wireless interface has a broader bandwidth (lower communication cost), the mobile node prefers transmission of data packets to the IEEE 802.11 wireless interface side. However, because the communication range of the IEEE 802.11 wireless interface is limited, connection is disconnected more frequently than with the stable cellular interface. When such disconnection occurs, the packets are required to be redirected to the cellular interface side. Because this redirection requires signaling, the packets are inevitably lost as a result of signaling delay.

Local mobility management reduces the chances of packet loss caused by signaling delay, but does not eliminate it. Here, when an instance is considered in which the mobile node changes from a certain MAG to another MAG, packets addressed to the mobile node that reach the LMA from when the mobile node loses connection with the previous MAG until the LMA receives a Proxy Binding Update (PBU) message from the new MAG are lost. As conventional technology for solving this problem, a method of returning a notification is proposed in Patent Document 1, below; a method of triggering a packet resending is proposed in Patent Document 2, below; and a method of reestablishing connection is proposed in Patent Document 3, below. However, all of these methods inevitably cause a delay in packet delivery and are therefore unacceptable for real-time applications such as Voice-Over IP (VoIP).

Another conventional technology is a high-speed handoff technology disclosed in Non-patent Document 5, Patent Document 4, Patent Document 5, Patent Document 6, and Patent Document 9, below. This technique includes predicting connection loss, and transmitting an empty signal to redirect packets from the IEEE 802.11 wireless interface to the cellular interface. However, the prediction of connection loss is not accurate, and the IEEE 802.11 wireless interface cannot be used effectively if redirection is performed too early.

In multihoming, a flow addressed to the home address or the home network prefix of the mobile node can be received via the plurality of interfaces of the mobile node, and a flow-type-based routing can be actualized in which the interface to be used is selected based on the type of flow for one or a plurality of desired interfaces of the mobile node. In general, setup of the flow-type-based routing mechanism in the system is started by the mobile node providing a filtering rule (routing rule) and being consequently decided or approved by an appropriate network entity. If the purpose of multihoming is to aggregate or increase bandwidth for the flow addressed to the home address or the home network prefix, the multihoming mechanism establishes a path having reachability in the home agent or the LMA, such that the flow addressed to the home address or the home network prefix reaches the mobile node via the plurality of interfaces of the mobile node. If the purpose of multihoming is that the mobile node wishes for the flow-type-based routing to be performed for one or a plurality of desired interfaces, in addition to establishing the above-described path having reachability, the mobile node is required to set up a flow-type-based filtering rule in the HA or the LMA. The important point is that, when the flow-type-based filtering rule is established in an anchor point (HA or LMA), the filtering rule is given priority over the ordinary address-based or prefix-based routing mechanism.

However, in the future 3GPP architecture, use of PMIPv6 to manage mobility of each interface of the mobile node, and use of DSMIPv6 supporting the multihoming function to actualize multihoming support for the mobile node, such as bandwidth aggregation, load sharing, and flow-type-based routing, can be strongly considered. In a hybrid scenario in which such PMIPv6 and DSMIPv6 supporting the multihoming function are used in combination, it is thought that DSMIPv6 supporting the multihoming function, such as those described in Non-patent Document 9 and Non-patent Document 10, will be used for the home network prefix allocated to the interface by the PMIPv6 mobility management mechanism. The PMIPv6 mobility management mechanism is known to efficiently provide mobility management. However, the method for multihoming is defined in more detail for DSMIPv6. Therefore, efficient mobility management and multihoming support can be easily actualized by combined operations of both mobility management mechanisms.

Next, in the above-described hybrid scenario in which both PMIPv6 and DSMIPv6 are used, a problem related to disconnection of an interface having unstable access will be described with reference to FIG. 18. A scenario in time sequence will hereinafter be described.

(1) A MN 200 first has an active WLAN interface IF2 that is connected to a LMM domain 210 via a WLAN access network 1101 and a MAG (WLAN) 232. In 3GPP, the MN is referred to as a user equipment (UE). The LMM domain 210 corresponds to a 3GPP Home Public Land Mobile Network (HPLMN), and PMIPv6 or other network-based mobility management protocol is used. In addition, the mobility of the MN 200 having the active WLAN interface IF2 is managed by DSMIPv6 or PMIPv6. It is clear to a person skilled in the art that DSMIPv6 and PMIPv6 may respectively be other host-based mobility management protocol and network-based mobility protocol.

(2) In FIG. 18, because the MN 200 also uses DSMIPv6, the MN 200 is notified of the address of a LMA/HA 220 by a certain server (not shown), such as a Dynamic Host Configuration Protocol (DHCP) server or a Domain Name Server (DNS). The LMA/HA 220 is indicated as a functional module providing the functions of both the LMA and the HA, and corresponds with a Packet Data Network (PDN) Gateway present within the 3GPP core network. The LMA/HA 220 is connected to a Packet Data Network (PDN) 1106. When the MN 200 is notified of the address of the LMA/HA 220, the MN 200 performs bootstrapping with the LMA/HA 220 and establishes a security association (SA) with the LMA/HA 220 to perform DSMIPv6 signaling. In the bootstrapping process, the MN 200 acquires a home prefix P1 for creating a home address HoA(P1) from the LMA/HA 220.

(3) Next, after the bootstrapping process, the MN 200 creates a care-of address CoA(P2) of the WLAN interface IF2 using a prefix P2 acquired by the PMIPv6 mechanism. The prefix P2 acquired via the WLAN interface IF2 is a prefix of which mobility is managed by the PMIPv6 mechanism. Furthermore, the prefix P2 is acquired by PMIPv6 mobility signaling 1110 between the LMA/HA 220 and the MAG(WLAN) 232, using the LMA/HA 220 as a geographical route. The signaling 1110 includes a PBU message and a PBA message. The prefix P2, or in other words, the external prefix, is provided from the MAG(WLAN) 232 to the MN 200 via a WLAN link 1108 in the layer 2 or the layer 3.

(4) Furthermore, the MN 200 has a 3GPP interface IF1 that is in idle mode. The 3GPP interface IF1 may be a Long Term Evolution (LTE)-type interface, a Universal Mobile Telecommunication System (UMTS)-type interface, or an interface unique to 3G such as that described in Non-patent Document 8. Idle mode refers to a state of the MN 200 in which, even when a base station of a 3G access network 1100 changes, the network is not notified of the attachment. In idle mode, the MN 200 performs location update in units of large areas referred to as tracking areas to save power.

(5) Next, the MN 200 of which the 3GPP interface IF1 is in idle mode attaches to a MAG 230 (3GPP) in the 3G access network 1100 via a 3GPP link 1107. Here, even though 3GPP access is in idle mode, the MN 200 is notified by the MAG 230 (3GPP) of a home prefix, namely the home prefix P1, via the 3GPP link 1107. The home prefix P1 in the MAG 230 (3GPP) is acquired by PMIPv6 mobility signaling (PBU message+PBA message) 1109. Therefore, the home prefix P1 acquired via 3GPP access is the same as the above-described home prefix P1 acquired by the bootstrapping process. In the 3GPP architecture, the notification of the home prefix P1 for LTE attachment is given during an attach procedure using Non-Access Stratum (NAS) protocol.

(6) Next, the MN 200 detects a home link by referencing the home prefix P1 during the attach procedure of 3GPP access and transmits a DSMIPv6-based BU message 1111 having multihoming parameters to the LMA/HA 220 via the WLAN access network 1101. The BU message 1111 is IPv6 mobility signaling. Furthermore, the care-of address CoA(P2) and a filter rule embedded within a flow identifier (FID) option are attached to the BU message 1111. The BU message 1111 further includes a binding identifier (BID), flow description sub-options, and a flag H indicating home and away registration.

The BU message 1111 serves two purposes. A first purpose is to generate a home and away registration (flag H=1) in the LMA/HA 220 such that data packets are selectively delivered to the home link (3GPP) or the WLAN link depending on the BID priority level for each interface, as described in Non-patent Reference 10, even when a filter rule is not present in the LMA/HA 220. A second purpose is to allow the MN 200 to use the filter rule to instruct the LMA/HA 220 that the MN 200 wishes for all arriving packets addressed to the prefix P1 to be delivered to the WLAN interface IF2. Ideally, the MN 200 wishes for all flows to be delivered via the WLAN access at all times when the WLAN access can be used. Even when the home and away registration is generated in the LMA/HA 220, the data flow is delivered via only the WLAN access as a result of a filter rule such as this. However, the WLAN access is unstable.

The important point here is that, when the MN 200 transmits the BU message 1111, it is possible for the MN 200 to not set a filter rule by setting the BID within the message to a high priority level. This is another method by which via-WLAN access is set as a default path. However, because a large number of actions in the LMA/HA 220 can be described by the filter rule, the filter rule is preferably set. A binding cache entry (BCE) 1112 is a BCE of the LMA/HA 220 capable of multihoming that has a DSMIPv6 binding having a registration for binding the HoA(P1) to the CoA(P2) and H=1, and a filter rule indicating that the default for packets addressed to P1 is the CoA(P2).

Next, other operations in FIG. 18 will be described.

(1) The MN 200 may use the addresses created from the prefixes P2 and P1 and set up a connection with a Correspondent Node (CN) (not shown) within PDN 1106. The prefix P1 is referenced via 3GPP access, and the prefix P2 is referenced via WLAN access. In addition, when a plurality of entities within the PDN 1106 are connected to the MN 200, the MN 200 may wish to set up a plurality of PDN connections, or may wish to perform a simple flow filtering by separating the flows by the prefixes P1 and P2. Here, PDN connection, default bearer setup, or connection refers to a connection established with the LMA/HA 220 to receive a number of services from the PDN 1106. In a scenario such as this, to actualize multihoming for a certain prefix (prefix P2 in this instance), the MN 200 transmits the BU message 1111 to the LMA/HA 220 and binds the HoA(P2) created from the prefix P2 to the HoA(P1) created from the prefix P1, as indicated in the BCE 1113.

(2) Here, the MN 200 has already performed bootstrapping with the LMA/HA 220, and has created the HoA(P1) and the HoA(P2) from the prefixes P1 and P2, respectively. Furthermore, the MN 200 writes a filter rule within the BU message 1111 and specifies the WLAN path as the default path for flows with the prefix P2. The filter rule (default for P2 packets→HoA(P2)) within the BCE 1113 at this time is shown in FIG. 18. In the filter rule, the flows with the prefix P2 are delivered via the WLAN access at all times.

(3) In a scenario such as this, the MN 200 loses connection (becomes disconnected) via the WLAN access because of mobility or for other reasons. In this instance, the MN 200 switches the stable 3GPP interface IF1 to active mode and transmits a service request message to a Mobility Management Entity (MME) (not shown in FIG. 18) via the 3GPP access network 1100. Functions of the MME are clearly described in Non-patent Document 9.

(4) When the MN 200 switches the 3GPP interface IF1 to active mode, because the filter rules (P1 packets→CoA(P1) and P2 packets→HoA(P1)) indicating that “all flows must be transmitted via the unstable WLAN access”, as indicated in the BCE 1112 and the BCE 1113, are set up in the LMA/HA 220, the data packets are not transferred or routed via the 3GPP access. The important point here is that, unless the MN 200 explicitly deletes the external binding registration (in other words, removes the binding between the HoA and the CoA), the filter-rule-based routing is performed. Here, a person skilled in the art can understand that the MN 200 can change the filter rule and set up the 3GPP path as the default path of the flows after the 3GPP connection is established. However, in this instance, a certain amount of delay occurs to set up or move the filter rule to the 3GPP path. Furthermore, when the MN 200 explicitly moves the filter rule to the 3GPP path, packet loss occurs, and the MN 200 experiences reduced session quality and reduced service quality. When packet loss occurs during connection with a stable access, this leads to reduced quality of the Quality of Service (QoS) for real-time applications.

(5) As a next postulation, when the MN 200 discovers another WLAN access after the elapse of some time after connection with the stable 3GPP access, the MN 200 may wish to reset the previous filter rule such as those indicated in BCE 1112 and BCE 1113. In this instance, the MN 200 is required to reset the old filter rule by explicit filter rule signaling. Furthermore, when the connection with the stable 3GPP access is returned to the connection with the preferable but unstable WLAN access, packet loss occurs because the target of the filter rule is still the stable 3GPP access.

When the MN 200 has an active real-time application and is roaming while moving its plurality of connections to the 3GPP access and further returning the connections to the WLAN access, a reduction in session quality occurs because of packet loss during the plurality of handoff events.

Furthermore, although the above-described problem of packet loss is described in relation to a common scenario, the problem also occurs when the MN 200 is connected to a Home Public Land Mobile Network (HPLMN), a Visited Public Land Mobile Network (VPLMN), or simultaneously connected to both HPLMN and VPLMN, as described in Non-patent Document 7 and Non-patent Document 8. In addition, although the above-described problem is described regarding when the 3GPP interface IF1 of the MN 200 is in idle mode, the problem also occurs when all interfaces of the MN 200 are connected completely in active mode.

Here, as another conventional technology, a method is described in Patent Document 10 [U.S. Pat. No. 7,136,645 B2] in which, when the mobile node has no reachability, is suspended, or is changing the network address for reasons such as the mobile node being interconnected by roaming from a certain network to another network, the mobility management server (HA or local anchor) retains the connection of the mobile node. However, even when the connection, or in other words, the binding is retained, the problem of packet loss cannot be solved when the binding is for a special purpose used only during a disconnection period and does not solve the problem of packet loss.

In addition, Patent Document 11 [US Patent Application Publication No. 2009/0080451 A1] describes a method of giving priority to a certain data flow over other flows. This method in particular relates to handling of priority levels. However, this method of handling priority levels is not related to filter rules, and cannot solve the problem of packet loss during disconnection or during handoff to a stable access.

In addition, N Document 12 [US Patent Application Publication No. 2008/0177994 A1] describes a method related to a reset function associated with the Windows (registered trademark) operating system. In this method, a certain state of the mobile node, such as an image of the operating system, is saved to a disk or a volatile memory after boot-up. When the mobile node is rebooted, the state is acquired, enabling immediate or instant start-up using the state. A method of storing and reusing a specific state can be applied to a filter rule that a certain active period and a certain inactive period. However, the above-described document does not describe how the stored state is useful for solving the problem of packet loss when the mobile node suddenly disconnects from unstable access.

In addition, Patent Document 13 [US Patent Application Publication No. 2003/0078006 A1] describes a method focusing on the lifecycles of an active period and an inactive period regarding when the mobile node receives a packet and beacon transmission of a base station. The description regarding active packet reception and transmission cannot necessarily solve the problem of cyclic packet loss during handoff by being applied to the filter rule in LMA/HA.

In addition, Patent Document 14 [PCT Patent Application Publication No. 2006/002379 A2] discusses a service table using packet types and the power mode of the mobile node as indicators. However, the above-described document does not describe the mobile node activating the mechanism during handoff to solve the problem of packet loss.

### PRIOR ART DOCUMENT

### Patent Document

Patent Document 1: Sturrock, et al., “Network Data Transmission”, US Patent Application Publication No. 2006/0041677A1, February 2006
Patent Document 2: Sturrock, et al., “Data Transmission over a Network”, US Application Publication No. 2006/0039350A1, February 2006
Patent Document 3: Sturrock, et al., “Transmitting Packets of Data”, US Patent Application Publication No. 2006/0039294A1, February 2006
Patent Document 4: Yang, et al., “System and Associated Mobile Node, Foreign Agent and Method for Link-Layer Assisted Mobile IP Fast Handoff”, U.S. Pat. No. 7,333,454B2, February 2008
Patent Document 5: Das, et al., “Continuous Mobility Across Wireless Networks by Integrating Mobile IP and GPRS Mobility Agents”, U.S. Pat. No. 7,039,404B2, May 2006
Patent Document 6: Chen, et al, “Packet Distribution and Selection in Soft Handoff for IP-Based Base Stations among Multiple Subnets”, U.S. Pat. No. 7,039,028B2, May 2006
Patent Document 7: Maenpaa, S. and Vesterinen, S., “A Method and System for Local Mobility Management”, PCT Patent Application Publication No. 03/107600A1, December 2003
Patent Document 8: Chari, A., et al., “A method of subnet roaming within a network”, PCT Patent Application Publication No. 2006/058206A2, June 2006
Patent Document 9: Park. S., et al., “Method and apparatus to provide for a handover on a wireless network”, PCT Patent Application Publication No. 2007/046624A1, April 2007
Patent Document 10: Hanson, et al., “Method and apparatus for providing mobile and other intermittent connectivity in a computing environment”, U.S. Pat. No. 7,136,645B2, November 2006
Patent Document 11: Gogic, “Priority scheduling and admission control in a communication network”, US Patent Application Publication No. 2009/0080451A1, March 2009
Patent Document 12: Mayer, “System and method for improving the efficiency, comfort, and/or reliability in Operating Systems, such as for example Windows”, US Patent Application Publication No. 2008/0177994A1, July 2008
Patent Document 13: Mahany, “Remote radio data communication system with data rate switching”, US Patent Application Publication No. 2003/0078006A1, April 2003
Patent Document 14: Jeong, M. R., et al., “Power mode aware packet communication method and apparatus”, PCT Patent Application Publication No. 2006/002379A2, January 2006

### Non-Patent Document

Non-patent Document 1: Johnson, D. B., Perkins, C. E., and Arkko, J., “Mobility Support in IPv6”, Internet Engineering Task Force Request For Comments 3775, June 2004
Non-patent Document 2: Devarapalli, V., et al., “Network Mobility (NEMO) Basic Support Protocol”, Internet Engineering Task Force Request For Comments 3963, January 2005
Non-patent Document 3: Gundavelli, S., et al., “Proxy Mobile IPv6”, Internet Engineering Task Force Draft draft-ietf-netlmm-proxymip6-11.txt, February 2008
Non-patent Document 4: Wakikawa, R., et al., “Multiple Care-of Addresses Registration”, Internet Engineering Task Force Draft: draft-ietf-monami6-multiplecoa-06.txt, February 2008
Non-patent Document 5: Koodli, R., “Fast Handovers for Mobile IPv6”, Internet Engineering Task Force Request For Comments 4068, July 2005
Non-patent Document 6: Gundavelli, S., et al., “Proxy Mobile IPv6”, Internet Engineering Task Force (IETF) Internet Engineering Task Force Request For Comments 5213, August 2008
Non-patent Document 7: “3rd Generation Partnership Project; Technical Specification Group Services and System Aspects; Architecture enhancements for non-3GPP accesses”, 3GPP TS 23.402, V8.4.1, January 2009
Non-patent Document 8: “3rd Generation Partnership Project; Technical Specification Group Services and System Aspects; General Packet Radio Service (GPRS) enhancements for Evolved Universal Terrestrial Radio Access Network (E-UTRAN) access”, 3GPP TS 23.401, V8.4.1, December 2008
Non-patent Document 9: Wakikawa, R., et al., “Multiple Care-of Addresses Registration”, Internet Engineering Task Force Working Group Draft: draft-ietf-monami6-multiplecoa-14.txt, May 2009
Non-patent Document 10: Soliman, H., et al., “Flow Bindings in Mobile IPv6 and Nemo Basic Support”, Internet Engineering Task Force Working Group Draft: draft-ietf-mext-flow-binding-03.txt, July 2009
Non-patent Document 11: Soliman, H., et al., “Mobile IPv6 Support for Dual Stack Hosts and Routers”, Internet Engineering Task Force Request For Comments 5555, June 2009

Therefore, a problem occurs in that, when a mobile node having a plurality of interfaces switches the interface to be used, the interface before switching cannot be effectively used when the switching timing is too early, and on the other hand, packet loss occurs when the switching timing is too late.

### SUMMARY OF THE INVENTION

In light of the above-described issues, an object of the present invention is to provide an interface switching system, a mobile node, a proxy node, and a mobile management node, in which the interface switching system is capable of preventing packet loss and transferring packets to a switched interface with minimal delay when a mobile node having a plurality of interfaces switches an interface to be used.

Another object of the present invention is to provide an interface switching system, a mobile node, a proxy node, and a mobile management node, in which the interface switching system is capable of preventing packet loss and transferring packets to a switched interface by flow type with minimal delay when a mobile node having a plurality of interfaces switches an interface to be used.

To achieve the above-described object, the present invention provides an interface switching system that switches a path between a mobile node having at least first and second interfaces and a mobility management node from a first path via the first interface and a first proxy node to a second path via the second interface and a second proxy node, the interface switching system including: a means for registering, from the first proxy node to the mobility management node, a first transfer information for establishing the first path; a means for registering in the first proxy node in advance by the mobile node, a second transfer information for establishing the second path, when the mobile node detects a change in a connection state of the first path; and a means for requesting, by the first proxy node or the mobile node, that the mobility management node invalidate the first transfer information and validate the second transfer information registered in advance, when the first proxy node or the mobile node detects an event that switches from the first path to the second path.

As a result of the configuration, when the mobile node having a plurality of interfaces switches the interface to be used, the first proxy node before switching or the mobile node requests a second binding registration of the switching destination, rather than the second proxy node of the switching destination making the request. Therefore, packet loss can be prevented and packets can be transferred to the interface of the switching destination with minimal delay.

To achieve the above-described object, the present invention provides a mobile node in an interface switching system that switches a path between the mobile node having at least first and second interfaces and a mobility management node from a first path via the first interface and a first proxy node to a second path via the second interface and a second proxy node, the mobile node including: a means for registering in the first proxy node in advance, a second transfer information for establishing the second path, when a change in a connection state of the first path is detected during communication via the first path.

To achieve the above-described object, the present invention provides a first proxy node in an interface switching system that switches a path between a mobile node having at least first and second interfaces and a mobility management node from a first path via the first interface and the first proxy node to a second path via the second interface and a second proxy node, the first proxy node including: a means for requesting that the mobility management node register a first transfer information for establishing the first path; a means for receiving from the mobile node, a message that registers in advance a second transfer information for establishing the second path; and a means for requesting that the mobile management node invalidate the first transfer information and validate the second transfer information registered in advance, when an event that switches from the first path to the second path is detected.

To achieve the above-described object, the present invention provides a mobility management node in an interface switching system that switches a path between a mobile node having at least first and second interfaces and the mobility management node from a first path via the first interface and a first proxy node to a second path via the second interface and a second proxy node, the mobility management node including: a means for receiving from the first proxy node, a request to register a first transfer information for establishing the first path, and registering the first transfer information; and a means for receiving from the first proxy node or the mobile node, a request for invalidation of the first transfer information and validation of a second transfer information for establishing the second path, and invalidating the first transfer information and validating the second transfer information.

In the present invention, when the mobile node having a plurality of interfaces switches the interface to be used, packet loss can be prevented and packets can be transferred to the interface of the switching destination with minimal delay.

In addition, in the present invention, when the mobile node having a plurality of interfaces switches the interface to be used, packet loss can be prevented and packets can be transferred to the interface of the switching destination by flow type with minimal delay.

### BRIEF DESCRIPTION OF THE DRAWINGS

FIG. 1 is a configuration diagram of an interface switching system postulated in the present invention;

FIG. 2 is a functional block diagram of a mobile node according to the preferred embodiments of the present invention;

FIG. 3 is a functional block diagram of a mobile access gateway according to the preferred embodiments of the present invention;

FIG. 4 is a functional block diagram of a local mobility anchor according to the preferred embodiments of the present invention;

FIG. 5 is an explanatory diagram of a communication sequence according to a first embodiment of the present invention;

FIG. 6 is an explanatory diagram of an example of a format of a binding in-advance registration message in FIG. 5;

FIG. 7 is an explanatory diagram of an example of a format of a registration delete/trigger message in FIG. 5;

FIG. 8 is an explanatory diagram of a communication sequence according to a second embodiment;

FIG. 9 is an explanatory diagram of an example of a format of a transfer message in FIG. 8;

FIG. 10 is an explanatory diagram of an example of a format of a response message in FIG. 8;

FIG. 11 is a configuration diagram of another system postulated in the present invention;

FIG. 12 is an explanatory diagram of a communication sequence according to a third embodiment;

FIG. 13 is an explanatory diagram of a communication sequence according to fourth and fifth embodiments;

FIG. 14 is an explanatory diagram of a communication sequence according to a sixth embodiment;

FIG. 15 is an explanatory diagram of an example of a format of a trigger message in FIG. 14;

FIG. 16 is a configuration diagram of an interface switching system according to a seventh embodiment;

FIG. 17 is an explanatory diagram of a communication sequence according to a seventh embodiment;

FIG. 18 is an explanatory diagram of a network according to an eighth embodiment;

FIG. 19 is an explanatory diagram of operations and communication sequence according to the eighth embodiment; and

FIG. 20 is operations and communication sequence according to a ninth embodiment.

### DESCRIPTION OF EMBODIMENTS

Embodiments of the present invention will hereinafter be described with reference to the drawings.

<System>

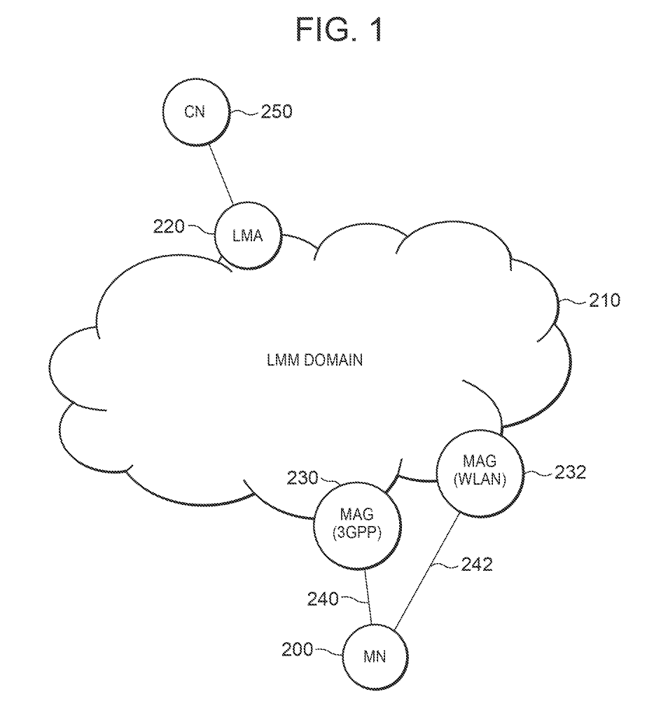

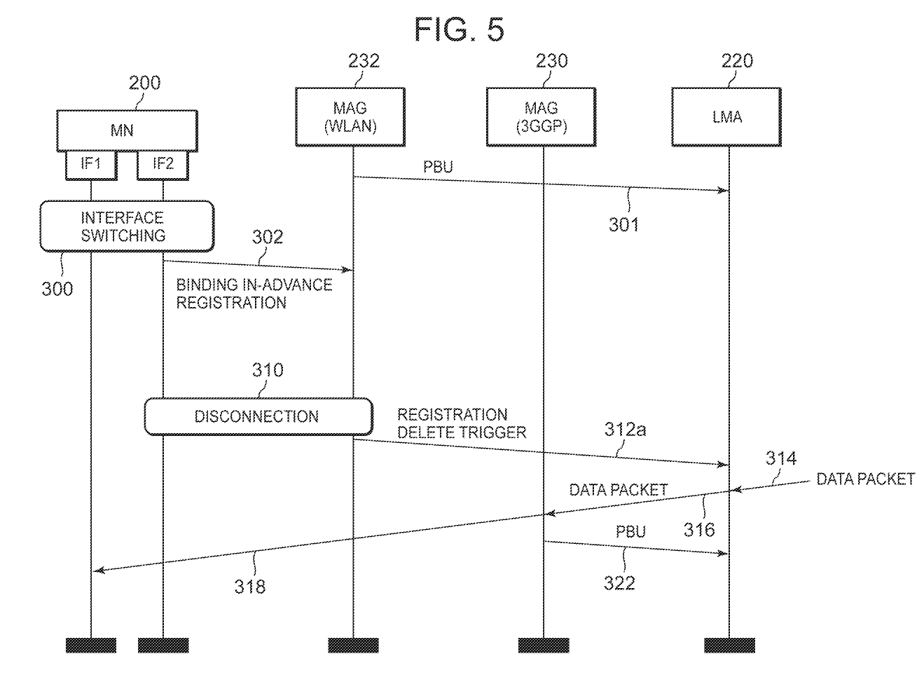

FIG. 1 shows an interface switching system postulated in the present invention. An MN 200 has a 3GPP interface IF1 and a WLAN interface IF2 (see FIG. 5) as examples of a plurality of network interfaces. The MN 200 communicates with a CN 250 using the interface IF1 or IF2 while roaming a local mobility management (LMM) domain 210. The LMM domain 210 has a local mobility anchor (LMA) 220 serving as a home agent (mobility management node) of the MN 200, a 3GPP mobile access gateway (MAG(3GPP)) 230 and a WLAN MAG(WLAN) 232 serving as proxy nodes of the MN 200, and an AAA server (not shown). The 3GPP interface IF1 and the WLAN interface IF2 respectively establish a cellular connection 240 and a WLAN connection 242 with the MAG(3GPP) 230 and the MAG(WLAN) 232. Here, because the WLAN connection 242 has a wider bandwidth than the cellular connection 240 and has lower communication cost, the MN 200 desires routing via the WLAN connection 242. However, compared to cellular, the WLAN access network has a narrow communication range or the communication range is scattered. Therefore, when the WLAN connection 242 is lost, the MN 200 actualizes a seamless handover from the WLAN connection 242 to the cellular connection 240 with minimal packet loss and delay. Here, cellular and WLAN are simply used for the description, and the present invention is not limited thereto.

<Configuration of MN>

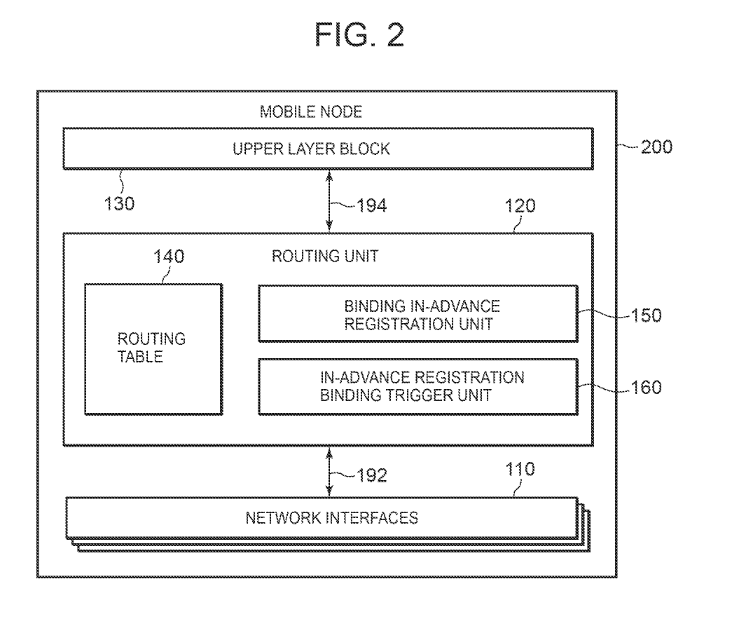

FIG. 2 is a functional block diagram of a configuration of the MN 200. The MN 200 has a plurality of network interfaces (referred to, hereinafter, as simply interfaces) 110 including the interfaces IF1 and IF2, a routing unit 120 that transfers a packet to a related program within the MN 200 or the interfaces 110, and an upper layer block 130 that performs protocols and programs of layers above the network layer. The interfaces 110 are a functional block that performs programs and software required for communication with another node via a communication medium. When terminology used within the related technical field is used, the interface 110 expresses communication components, firmware, drivers, and communication protocols of the layer 1 (physical layer) and the layer 2 (data link layer).

The routing unit 120 decides the appropriate program within the upper layer block 130 to which to send a packet for processing, and decides the appropriate interface within the interfaces 110 to which to send a packet for transfer. When terminology used within the related technical field is used, the routing unit 120 expresses the functions of the layer 3 (network layer) protocols, such as Internet Protocol version 4 or 6 (IPv4 or IPv6). The routing unit 120 is capable of receiving a packet from the appropriate interface of the interfaces 110 and transmitting a packet to the appropriate interface of the interfaces 110, via a signal/data path 192. In addition, the routing unit 120 is capable of receiving a packet from the upper layer block 130 and transmitting a packet to the upper layer block 130, via a signal/data path 194.

The protocols and programs of the layers above the network layer performed by the upper layer block 130 include transport layer and session layer protocols, such as Transmission Control Protocol (TCP), Stream Control Transport Protocol (SCTP), and User Datagram Protocol (UDP), and programs and software required for communicating with another node.

The routing unit 120 has a routing table 140, a binding in-advance registration unit 150, and an in-advance registration binding trigger unit 160. The routing table 140 includes routing entries (such as a transmission source address and a destination address) indicating to the routing unit 120 the interface of the interfaces 110 to which to route the packet. The binding in-advance registration unit 150 and the in-advance registration binding trigger unit 160 are core sections added in the present invention. The binding in-advance registration unit 150 transmits to an access router, a message for registering in advance a binding registration having active conditions (transfer destination information associating a certain single prefix with another prefix or associating a certain single home address with another home address), rather than a condition-less binding registration request message such as a BU message or a PBU message. In addition, when the in-advance registration message includes a lifetime, the binding in-advance registration unit 150 refreshes the lifetime when the lifetime ends or nears its end.

The binding in-advance registration unit 150 also registers a flow-type-specific in-advance registration filter rule having an active period and an inactive period according to an eighth embodiment, and registers a flow-type-specific in-advance registration blocking filter rule having an active period and an inactive period according to a ninth embodiment. The in-advance registration binding trigger unit 160 triggers the binding in-advance registration unit 150 to transmit a message for registering in advance the binding registration, the flow-type-specific in-advance registration filter rule, or the flow-type-specific in-advance registration blocking filter rule. In addition, when required, the in-advance registration binding trigger unit 160 transmits to an access router, a trigger signal for activating the in-advance registration binding, the flow-type-specific in-advance registration filter rule, or the flow-type-specific in-advance registration blocking filter rule registered in the access router.

<Configuration of MAG>

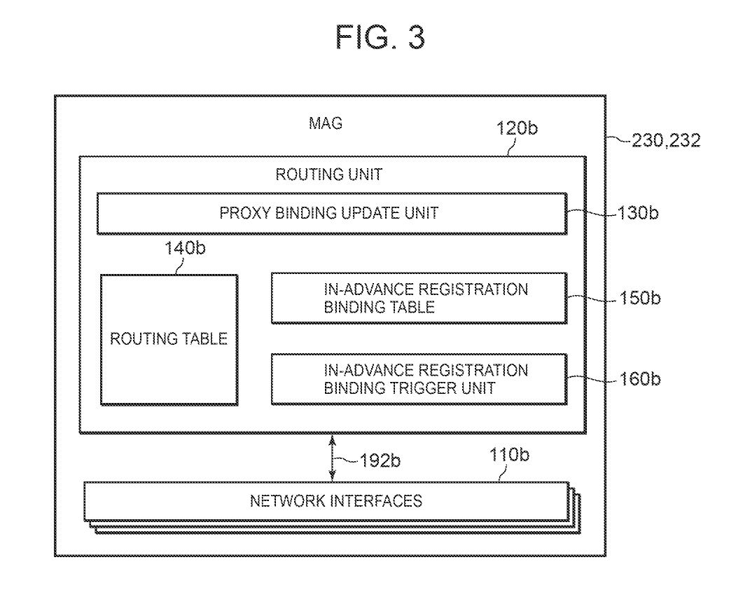

FIG. 3 is a functional block diagram of the configurations of the MAG(3GPP) 230 and the MAG(WLAN) 232. The MAG 230 and 232 have one or a plurality of network interfaces (referred to, hereinafter, as simply interfaces) 110b for transmitting and receiving packets, and a routing unit 120b that decides the appropriate interface of the interfaces 110b via which a packet is transferred. The interfaces 110b is similarly a functional block that performs programs and software required for communicating with another node via a communication medium, and indicates the communication components, firmware, drivers, and communication protocols of the layer 1 (physical layer) and the layer 2 (data link layer).

The routing unit 120b decides the appropriate interface within the interfaces 110 to which to send a packet for transfer. Furthermore, the routing unit 120b provides a function as a proxy mobile IP (PMIP) MAG and, when terminology used in the related technical field is used, expresses the functions of the layer 3 (network layer) protocols, such as IPv4 or IPv6. The routing unit 120b is capable of receiving a packet from the appropriate interface of the interfaces 110b and transmitting a packet to the appropriate interface of the interfaces 110b, via a signal/data path 192b.

The routing unit 120b includes a proxy binding update (PBU) unit 130b, a routing table 140b, an in-advance registration binding table 150b, and an in-advance registration binding trigger unit 160b. The PBU unit 130b transmits to the LMA 220, a PBU message for the MN 200 that is currently attached to its own MAG 230 or 232. The routing table 140b has routing entries for instructing the routing unit 120b how to route a packet and has packet parameters (transmission source address and destination address) indicating, for example, the interface via which transfer is performed.

The in-advance registration binding table 150b and the in-advance registration binding trigger unit 160b are core sections added in the present invention. The in-advance registration binding table 150b stores therein the binding registered in advance by the MN 200 (the in-advance registration binding, the flow-type-specific in-advance registration filter rule, or the flow-type-specific in-advance registration blocking filter rule). The in-advance registration binding trigger unit 160b activates the in-advance registration binding, the flow-type-specific in-advance registration filter rule, or the flow-type-specific in-advance registration blocking filter rule stored in the in-advance registration binding table 150b when a certain event is generated. In addition, when required, the in-advance registration binding trigger unit 160b transfers the in-advance registration binding, the flow-type-specific in-advance registration filter rule, or the flow-type-specific in-advance registration blocking filter rule to the LMA 220.

<Configuration of LMA>

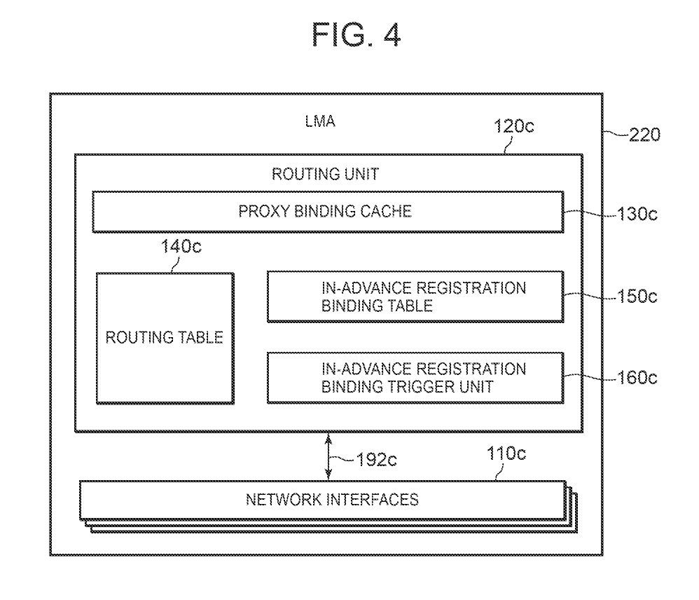

FIG. 4 is a functional block diagram of a configuration of the LMA 220. The LMA 220 has one or a plurality of network interfaces (referred to, hereinafter, as simply interfaces) 110c for transmitting and receiving packets, and a routing unit 120 that decides the appropriate interface of the interfaces 110c via which a packet is transferred. The interfaces 110c is similarly a functional block that performs programs and software required for communicating with another node via a communication medium, and expresses the communication components, firmware, drivers, and communication protocols of the layer 1 (physical layer) and the layer 2 (data link layer).

The routing unit 120c decides the appropriate interface within the interfaces 110 to which to send a packet for transfer. Furthermore, the routing unit 120b provides a function as a proxy mobile IP (PMIP) LMA and, when terminology used in the related technical field is used, expresses the functions of the layer 3 (network layer) protocols, such as IPv4 or IPv6. The routing unit 120c is capable of receiving a packet from the appropriate interface of the interfaces 110c and transmitting a packet to the appropriate interface of the interfaces 110c, via a signal/data path 192c.

The routing unit 120c includes a proxy binding cache 130c, a routing table 140c, an in-advance registration binding table 150c, and an in-advance registration binding trigger unit 160c. The proxy binding cache 130c retains a proxy binding registration of the MN 200 based on PMIP. The routing table 140c has routing entries for instructing the routing unit 120c how to route a packet and has packet parameters (transmission source address and destination address) indicating, for example, the interface via which transfer is performed.

The in-advance registration binding table 150c and the in-advance registration binding trigger unit 160c are core sections added in the present invention. The in-advance registration binding table 150c stores therein a binding registered in advance by the MN 200 and the MAG 230 and 232 (the in-advance registration binding, the flow-type-specific in-advance registration filter rule, or the flow-type-specific in-advance registration blocking filter rule). The in-advance registration binding trigger unit 160c activates the in-advance registration binding, the flow-type-specific in-advance registration filter rule, or the flow-type-specific in-advance registration blocking filter rule stored in the in-advance registration binding table 150c when a certain event is generated.

### First Embodiment

FIG. 5 shows a communication sequence according to a first embodiment. First, the MN 200 is communicating (connected) with the MAG(WLAN) 232. Therefore, a PBU message 301 has already been transmitted from the MAG(WLAN) 232 to the LMA 220, and binding related to the WLAN connection 242 is already registered in the LMA 220. When an interface switching event 300 is generated during communication with the MAG(WLAN) 232, the MN 200 transmits to the MAG(WLAN) 232 via the WLAN connection 242, a binding in-advance registration message 302 to register in advance a binding registration related to the cellular connection 240. Examples of the interface switching event 300 include one or more of: when signal strength of the WLAN connection 242 drops below a predetermined threshold; when loss of the WLAN connection 242 is predicted by detection of the moving speed of the MN 200; and when the MN 200 has started a real-time communication session via the WLAN connection 242 and desires minimal packet loss, delay, and the like.

The binding in-advance registration message 302 includes the desire of the MN 200 to establish the cellular connection 240 in place of the current WLAN connection 242 binding. Here, as the method of identifying the replacement cellular connection 240, there are various preferable methods. For example, when a unique prefix is assigned to each of the cellular connection 240 and the WLAN connection 242, the prefix of the cellular connection 240 is used. Alternatively, an interface identifier of the 3GPP interface IF1 is used. The binding in-advance registration message 302 also indicates a method for activating the in-advance registration binding of the cellular connection 240. For example, when the WLAN connection 242 is disconnected, when the MAG(WLAN) 232 receives a certain signal, or the like is indicated as information for activating the in-advance registration binding. In FIG. 5, the in-advance registration binding is activated when the WLAN connection 242 is disconnected (310 in the drawing).

When the MAG(WLAN) 232 receives the binding in-advance registration message 302 for the cellular connection 240, the MAG(WLAN) 232 registers the in-advance registration binding in the in-advance registration binding table 150b. Here, the cellular connection 240 binding is merely temporarily registered and is not active (fully registered). Therefore, the packets addressed to the MN 200 are continuously transferred via the MAG(WLAN) 232 and the WLAN connection 242. The transfer via WLAN is continued until the WLAN connection 242 is disconnected (310 in the drawing). Here, in the layer 2 access technology, the access router can instantly detect that the mobile node has lost connection.

When the MAG(WLAN) 232 detects the disconnection 310 of the WLAN connection 242, the MAG(WLAN) 232 transmits a registration delete/trigger message 312a to the LMA 220. The registration delete/trigger message 312a serves two purposes. A first purpose is to register and trigger to LMA 220 (in other words, fully register) the in-advance registration binding of the cellular connection 240 registered in the MAG(WLAN) 232. A second purpose is to delete the binding registration (content of the PBU message 301) of the prefix allocated to the WLAN interface IF2 from the MAG(WLAN) 232. Therefore, when the LMA 220 receives the registration delete/trigger message 312a, the LMA 220 transfers the via-WLAN connection 242 data packets of the MN 200 via cellular connection 240. The registration deletion described herein may refer to cancellation of the registration as a binding, rather than deletion of the binding-registered information itself. In this instance, when the LMA 220 receives the registration delete/trigger message 312a, the LMA 220 deactivates (invalidates) the binding registration of the prefix allocated to the WLAN interface IF2. Therefore, the binding information related to the prefix of the WLAN interface IF2 is held, and is activated (validated) when the MN 200 reestablishes the WLAN connection 242. In other words, although the registration is cancelled, the actual information is held without being deleted. As a result, when the WLAN of the MN 200 is reconnected, the binding information is not required to be reregistered.

Here, when the LMA 220 receives a data packet 314 of the MN 200 that is transferred via the WLAN connection 242 is considered. At this time, because the MN 200 is already detached from the MAG(WLAN) 232, in conventional technology, the data packet 314 is transferred to the MAG(WLAN) 232 but discarded because the MN 200 is no longer attached to the MAG 232. On the other hand, in the present invention, the in-advance registration binding of the cellular connection 240 registered in the MAG(WLAN) 232 is fully registered in the LMA 220. Therefore, the data packet 314 is transferred to the MAG 230 as indicated by a transfer path 316, and the MAG 230 transfers the data packet 314 to the MN 200 via the cellular connection 240 as indicated by a transfer path 318.

This operation differs from an ordinary PMIPv6 operation. In the ordinary PMIPv6 operation, the MAG(3GPP) 230 is required to transmit a PBU message 322 and use a handoff instruction flag to give an instruction to move the prefix related to the WLAN connection 242. On the contrary, according to the present embodiment, when the in-advance registration binding of the cellular connection 240 is activated, the LMA 220 is able to start the transfer to the MAG(3GPP) 230 even before receiving the PBU message 322 of the cellular connection 240. As described above, according to the present embodiment, even when the WLAN connection 242 is lost, the packets addressed to the MN 200 are transferred to a different cellular connection 240 with minimal delay, without being discarded.

<Binding In-Advance Registration Message>

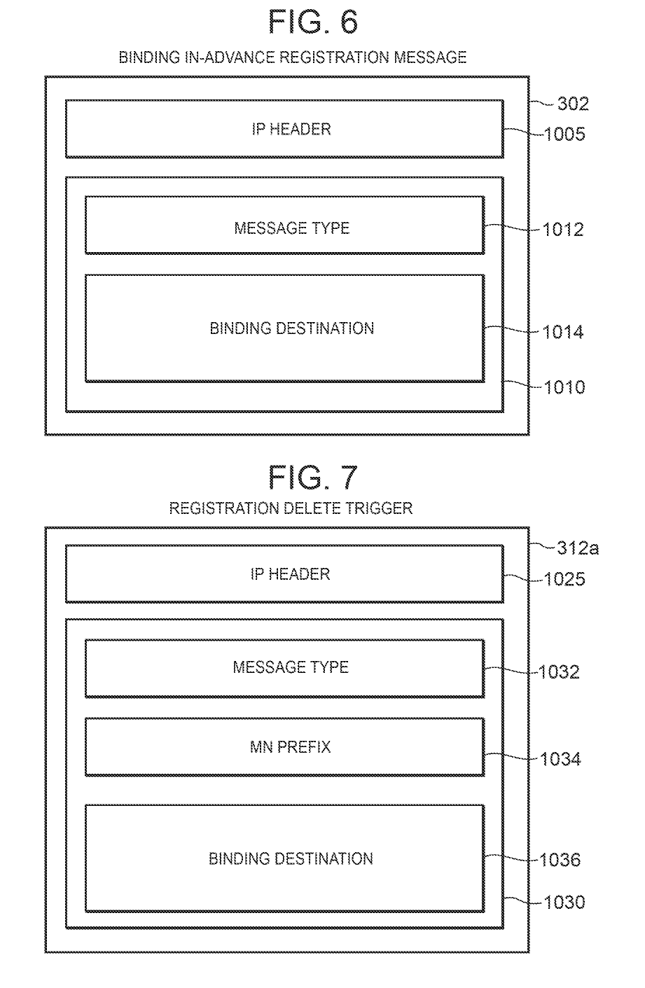

FIG. 6 shows an example of a format of the binding in-advance registration message 302. The message 302 includes an IP header 1005 when the message 302 uses IP. The actual message 1010 follows the IP header 1005. When the message 302 is transmitted via the layer 2 mechanism, the IP header 1005 is replaced with an appropriate layer 2 frame header. The actual message 1010 includes each of a message type 1012 field and a binding destination 1014 field. The message type 1012 indicates that the message 302 is the in-advance registration of a binding registration. The binding destination 1014 indicates information (transfer destination information) regarding the binding destination of the in-advance registration binding and indicates the connection to serve as the transfer destination of the packet when the in-advance registration binding becomes active. For example, the binding destination 1014 is information (such as an address or ID) identifying the network prefix or the MAG of the binding destination, the binding destination interface of the MN 200, or the like. As the binding in-advance registration message 302, signaling exchanged during the attach procedure performed when connecting to the MN 200 and the MAG(WLAN) 232 may be used, or signaling exchanged during an Internet Key Exchange (IKEv2) performed to establish a Security Association (SA) between the MN 200 and the MAG(WLAN) 232 may be used. Alternatively, a BU message may be used.

<Registration Delete/Trigger Message>

FIG. 7 shows an example of a format of the registration delete/trigger message 312a. The message 312a provides a function for registering and activating the in-advance registration binding in the LMA 220, and a function as a PBU message for registration deletion in PMIP. The message 312a includes an IP header 1025 when the message 312a uses IP. An actual message 1030 follows the IP header 1025. When the message 312a is transmitted via the layer 2 mechanism, the IP header 1025 is replaced with an appropriate layer 2 frame header. The actual message 1030 includes each of a message type 1032 field, an MN prefix 1034 field, and a binding destination 1036 field. The message type 1032 indicates that the message 312a is a registration delete/trigger message. The MN prefix 1034 is a prefix of the MN 200 handled by the transmission source MAG of the message 312a and indicates the prefix of which registration is to be deleted. The binding destination 1036 indicates the binding destination of the in-advance registration binding and indicates the connection to serve as the transfer destination of the packet when the in-advance registration binding becomes active. For example, the binding destination 1036 is information (such as an address or ID) identifying the network prefix or the MAG of the binding destination, the binding destination interface of the MN 200, or the like. A PBU message may be used as the registration delete/trigger message 312a.

### Second Embodiment

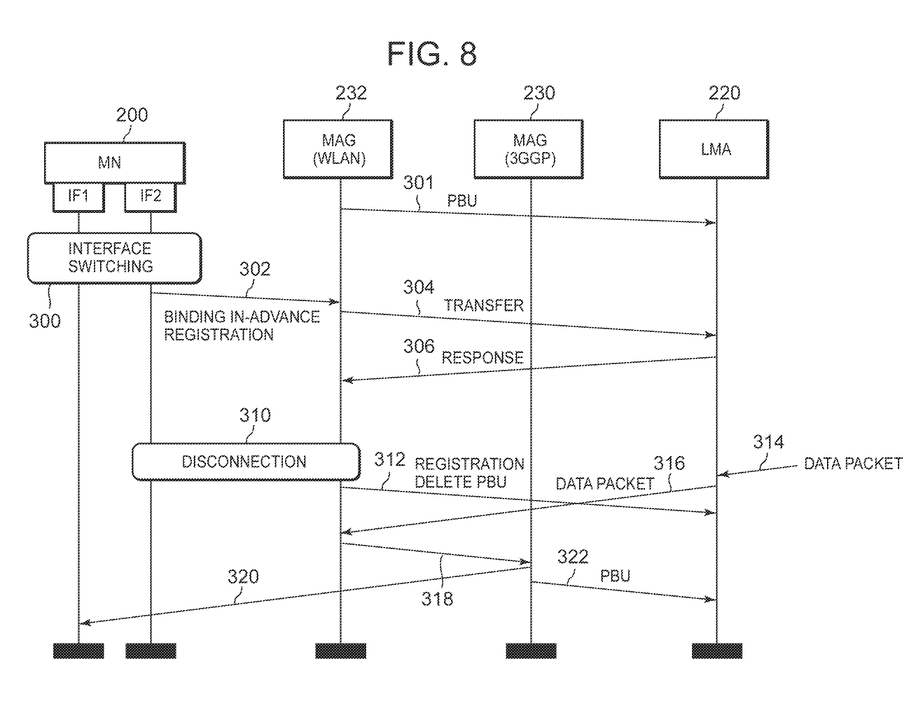

FIG. 8 shows a communication sequence according to a second embodiment. The MN 200 is communicating (connected) with the MAG(WLAN) 232. Therefore, the PBU message 301 has already been transmitted from the MAG(WLAN) 232 to the LMA 220, and the binding related to the WLAN connection 242 is already registered in the LMA 220. When an interface switching event 300 is generated during communication with the MAG(WLAN) 232, the MN 200 transmits the binding in-advance registration message 302 to the MAG(WLAN) 232 via the WLAN connection 242, the MN 200 transmits the binding in-advance registration message 302 to the MAG(WLAN) 232 via the WLAN connection 242. The binding in-advance registration message 302 includes the desire of the MN 200 to establish the cellular connection 240 in place of the current WLAN connection 242 binding. The interface switching events and the method of identifying the replacement cellular connection 240 are similar to those according to the first embodiment. In addition, the binding in-advance registration message 302 indicates a method of activating the in-advance registration binding of the cellular connection 240. For example, when the WLAN connection 242 is disconnected, when the MAG(WLAN) 232 receives a specific signal, and the like are indicated as information for activating the in-advance registration binding. In FIG. 8, the in-advance registration binding is activated when the WLAN connection 242 is disconnected (310 in the drawing).

When the MAG(WLAN) 232 receives the binding in-advance registration message 302, the MAG(WLAN) 232 registers the content in the in-advance registration binding table 150b and transfers the binding in-advance registration message 302 to the LMA 220 by a binding in-advance registration transfer message 304. The transfer message 304 serves two purposes. A first purpose is to perform temporary binding registration in the LMA 220 of the prefix related to the WLAN connection 242 to the prefix related to the cellular connection 240. Therefore, the LMA 220 registers the in-advance registration binding within the transfer message 304 in the in-advance registration binding table 150c. This means that, when the in-advance registration binding of the cellular connection 240 in the LMA 220 is activated, the LMA 220 tunnels a packet addressed to the MAG(WLAN) 232 to the MAG(3GPP) 230 instead.

A second purpose of the transfer message 304 is to request that the LMA 220 notify the MAG(WLAN) 232 of the address of the MAG(3GPP) 230 to serve as proxy in the cellular connection 240, information such as FQDN enabling the address to be derived, or the like. Therefore, the LMA 220 transmits a response message 306 to the MAG(WLAN) 232 and gives notification that the MAG(3GPP) 230 is the proxy node in the cellular connection 240. Here, when the MAG(WLAN) 232 has other means of knowing the MAG(3GPP) 230, the transfer message 304 is not required. As these other means, the following can be considered: the MN 200 finding the address of the MAG(3GPP) 230 or information enabling the address to be derived from the network prefix related to the cellular connection 240 or other parameters; or the MN 200 finding the address by making a query to an independent server within the domain 210 and explicitly notifying the MAG(WLAN) 232 using the binding in-advance registration message 302.

Through the messages 302, 304, and 306, the temporary binding is registered in both the MAG(WLAN) 232 and the LMA 220, but is still inactive. Therefore, the packets addressed to the MN 200 continue being transferred via the MAG(WLAN) 232 and the WLAN connection 242. The transfer via WLAN continues until the WLAN connection 242 is disconnected (310 in the drawing). Here, in the layer 2 access technology, the access router can instantly detect that the mobile node has lost connection.

When the MAG(WLAN) 232 detects the disconnection 310 of the WLAN connection 242, the MAG(WLAN) 232 transmits to the LMA 220, a proxy BU (registration delete PBU) message 312 requesting deletion of the binding registration related to the WLAN connection 242 (in other words, the content of the PBU message 301) by proxy mobile IP, to activate the in-advance registration binding registration of the cellular connection 240. When the LMA 220 receives the registration delete PBU message 312, the LMA 220 deletes the binding registration of the prefix allocated to the WLAN interface IF2 from the MAG(WLAN) 232 and activates the in-advance registration binding of the cellular connection 240. The registration deletion described herein may refer to cancellation of the registration as a binding, rather than deletion of the binding-registered information itself. In this instance, when the LMA 220 receives the registration delete PBU message 312a, the LMA 220 deactivates (invalidates) the binding registration of the prefix allocated to the WLAN interface IF2. Therefore, the binding information related to the prefix of the WLAN interface IF2 is held, and is activated (validated) when the MN 200 re-establishes the WLAN connection 242. In other words, although the registration is cancelled, the actual information is held without being deleted. As a result, the binding information is not required to be reregistered when the MN 200 reconnects.

Here, if the LMA 220 has received the data packet 314 to be transferred via the WLAN connection 242 before receiving the registration delete PBU message 312, the LMA 220 tunnels the data packet 314 in a data packet 316 addressed to the MAG(WLAN) 232 as an ordinary operation, because the in-advance registration binding for the cellular connection 240 has not been activated. Then, when the MAG(WLAN) 232 receives the data packet 316, because the in-advance registration binding for the cellular connection 240 has been activated, the MAG(WLAN) 232 intercepts the data packet 316 and transfers the data packet 316 by a data packet 318 to the MAG(3GPP) 230. As a result, even when the MAG(WLAN) 232 receives the data packet 316 after detecting the disconnection 310 of the WLAN connection 242, because the MAG(WLAN) 232 is able to perform transfer to the MAG(3GPP) 230, packet loss can be prevented. Here, the MAG(WLAN) 232 knows the MAG(3GPP) 230 that is the transfer destination of the data packet 318 by the response message 306 or other means. The MAG(3GPP) 230 transfers the data packet 318 by a data packet 320 to the MN 200.

When the LMA 220 receives a data packet when the in-advance registration binding of the cellular connection 240 is activated (in other words, after receiving the registration delete PBU message 312), the LMA 220 transfers the data packet to the MAG(3GPP) 230 in place of the MAG(WLAN) 232. This operation differs from the ordinary PMIPv6 operation. In the ordinary PMIPv6 operation, the MAG(3GPP) 230 is required to transmit the PBU message 323 of the cellular connection 240 and use a handoff instruction flag to give an instruction to move the prefix related to the WLAN connection 242. On the contrary, according to the present embodiment, when the in-advance registration binding of the cellular connection 240 is activated, the LMA 220 is able to start the transfer to the MAG(3GPP) 230 even before receiving the PBU message 322 of the cellular connection 240. As described above, according to the present embodiment, even when the WLAN connection 242 is lost, the packets addressed to the MN 200 are transferred to a different cellular connection 240 with minimal delay, without being discarded.

<Binding In-Advance Registration Transfer Message>

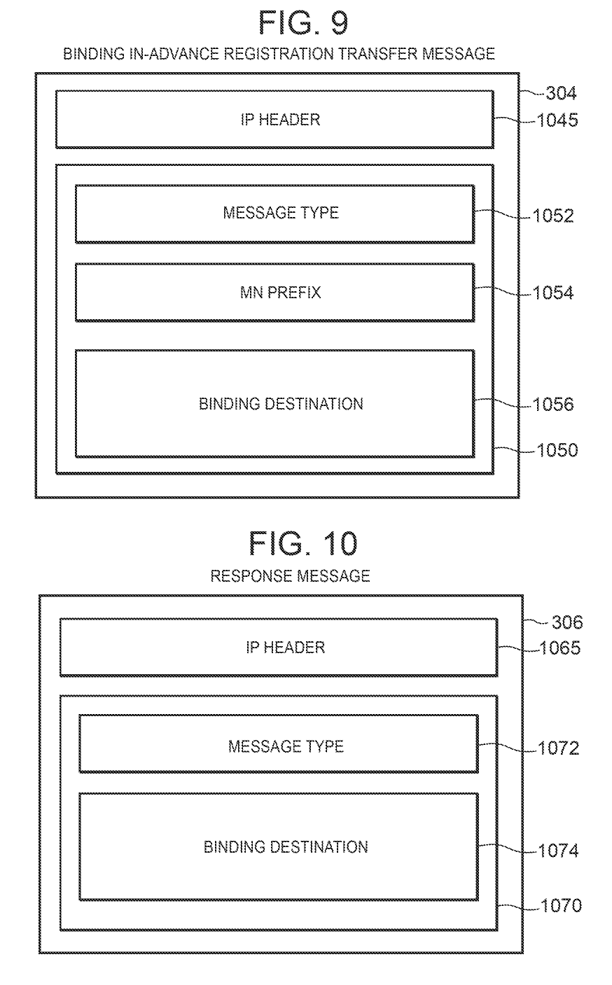

FIG. 9 shows an example of a format of the binding in-advance registration transfer message 304. The message 304 provides a function for registering the in-advance registration binding in the LMA 220 and a function for requesting that the LMA 220 notify the transmission source of the message of information (such as an address) related to the MAG handling the binding destination written within the message 304. The message 304 includes an IP header 1045 when the message 304 uses IP. An actual message 1050 follows the IP header 1045. The actual message 1050 includes each of a message type 1052 field, an MN prefix 1054 field, and a binding destination 1056 field. The message type 1052 indicates that the message is the in-advance registration transfer message 304. The MN prefix 1054 is the prefix of the MN 200 handled by the transmission source MAG of the message and indicates the prefix to which packets should be transferred when the in-advance registration binding is activated. The binding destination 1056 indicates the binding destination of the in-advance registration binding and indicates the connection to serve as the transfer destination of the packet when the in-advance registration binding becomes active. For example, the binding destination 1056 is information (such as an address or ID) identifying the network prefix or the MAG of the binding destination, the binding destination interface of the MN 200, or the like. A PBU message may be used as the binding in-advance registration transfer message 304.

<Response Message>

FIG. 10 shows an example of a format of the response message 306. The message 306 includes an IP header 1065 when the message 306 uses IP. An actual message 1070 follows the IP header 1065. The actual message 1070 includes each of a message type 1072 field and a binding destination 1074 field. The message type 1072 indicates that the message is the response message 306. The binding destination 1074 is the actual address of the MAG handling the binding destination written in the in-advance registration binding. A PBA message may be used as the response message 306.

### Third Embodiment

### Changing Binding Destination

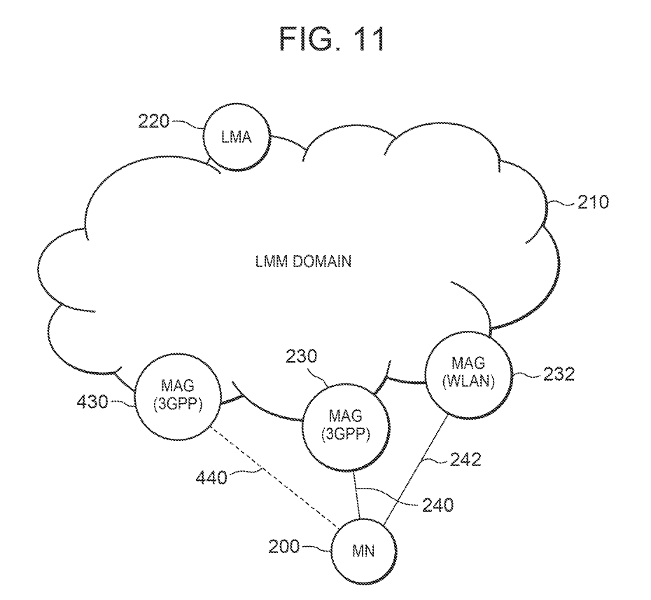

Ordinarily, the mobile node binds an unstable connection to a stable connection as the in-advance registration binding. Because the connection of the binding destination (the interface to which the interface is switched) is stable, the connection of the binding destination is rarely changed before the in-advance binding is activated. However, an instance such as the following can be considered. FIG. 11 shows another system postulated in the present invention. In FIG. 11, a cellular access type MAG(3GPP) 430 is added to the configuration shown in FIG. 1.

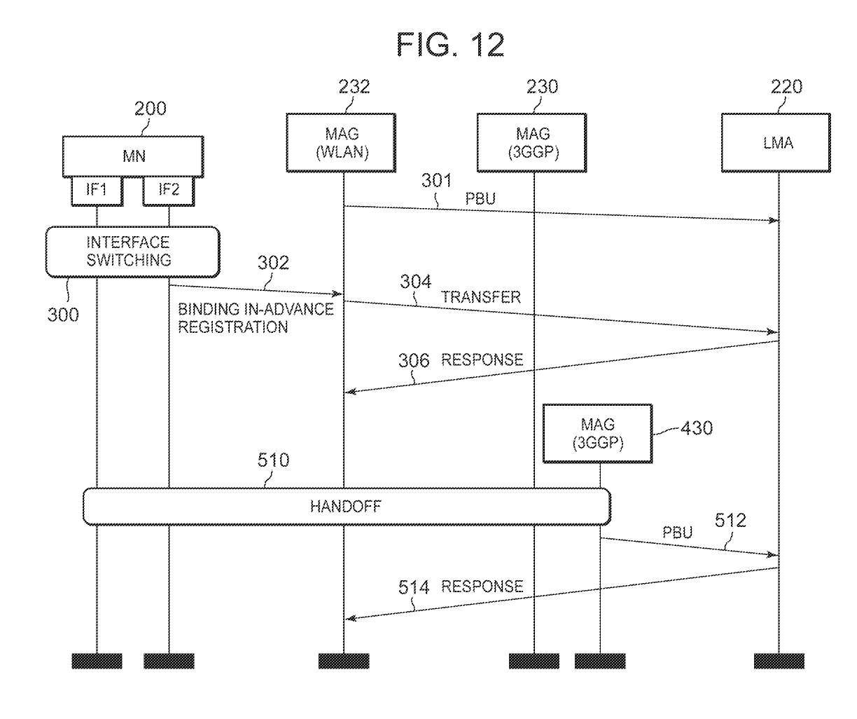

FIG. 12 shows a communication sequence in FIG. 11, and includes a procedure for handing off the cellular connection 240 between the MN 200 and the MAG(3GPP) 230 to a new cellular connection 440 between the MN 200 and the MAG(3GPP) 430. The PBU message 301, the interface switching event 300, the binding in-advance registration message 302, the transfer message 304, and the response message 306 in FIG. 12 are the same as those in FIG. 8. Therefore, although the in-advance registration binding of the cellular connection 240 is registered in both the in-advance registration binding table 150b of the MAG(WLAN) 232 and the in-advance registration binding table 150c of the LMA 220, the in-advance registration binding is still inactive. Therefore, the packets addressed to the MN 200 are continuously transferred via the MAG (WLAN) 232 and the WLAN connection 242. In addition, the MAG 232 is notified that the cellular connection 240 is managed by the MAG 230 by the response message 306 from the LMA 220. The transfer via the cellular connection 240 is continued until the cellular connection 240 is switched to the cellular connection 440, as indicated by an event 510.

When the cellular connection 240 is handed off to cellular connection 440 (510 in the drawing), the new MAG(3GPP) 430 transmits a PBU message 512 of the cellular connection 440 to the LMA 220 and updates the cellular connection 240 to the new cellular connection 440. The PBU message 512 indicates to the LMA 220 that the MAG(3GPP) 430 is currently handling the cellular connection of the MN 200. Because the LMA 220 has already registered in the in-advance registration binding for the cellular connection 240 by the transfer message 304, the LMA 220 checks the in-advance registration binding table for whether the in-advance registration binding is affected by the PBU message 512.

When the LMA 220 detects that the binding destination of the in-advance registration binding of the cellular connection 240 has been changed, the LMA 220 transmits a new response message 514 to the MAG(WLAN) 232 and gives notification that the binding destination of the in-advance registration binding has been changed from the MAG(3GPP) 230 to the MAG(3GPP) 430. Because the MAG(WLAN) 232 is notified of the binding destination even when the binding destination of the in-advance registration binding of the cellular connection 240 has been changed, the MAG(WLAN) 232 can transfer to the correct MAG(3GPP) 430, the packet transferred from the LMA 220 after disconnection of the WLAN connection 242. As a result, even when the WLAN connection 242 is lost, the packets addressed to the MN 200 are transferred to a different cellular connection 440 with minimal delay, without being discarded.

### Fourth Embodiment

### Checking Binding Destination

According to a certain system, the MAG(WLAN) 232 may be required to verify whether or not the MN 200 really has the cellular connection 240 of the binding destination before receiving the above-described in-advance registration binding. The verification can be actualized by the MAG(WLAN) 232 requesting verification when transmitting the transfer message 304 to the LMA 220, and receiving an affirmative response message 306 from the LMA 220. Alternatively, the MAG(WLAN) 232 can make a query to another node within the domain 210 that has the required information related to the active connection of the MN 200, such as the AAA server. As still another method, the MAG(WLAN) 232 transmits a test message to the cellular connection 240 of the binding destination. When the MN 200 receives the test message, the MN 200 indicates that it really has the cellular connection 240 of the binding destination by responding.

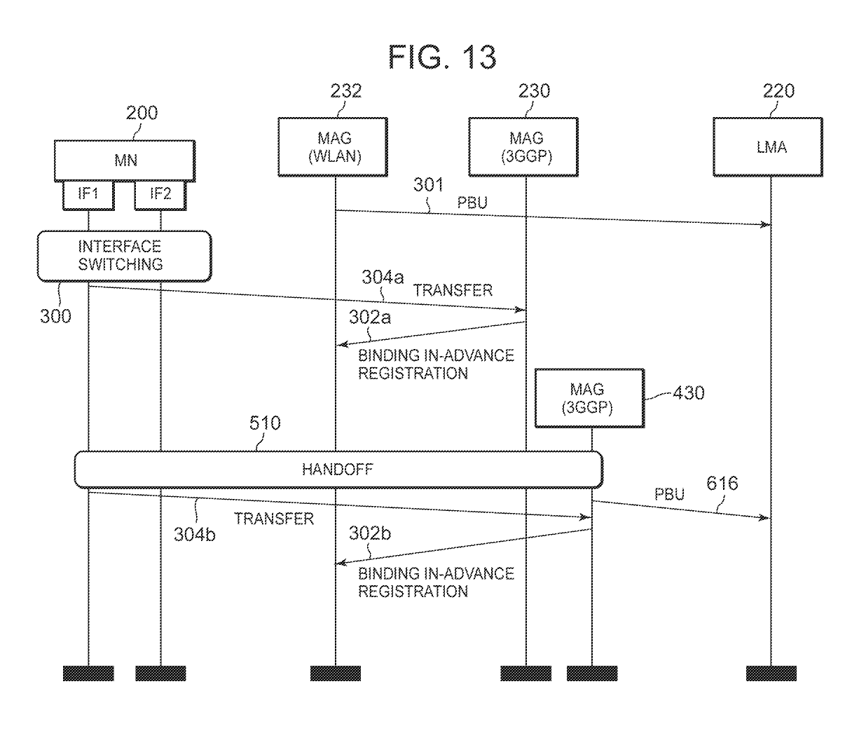

As still another method, as shown in FIG. 13, the MN 200 transmits a binding in-advance registration message 302a to the MAG(WLAN) 232 via the cellular connection 240 of the binding destination. In this instance, because the binding in-advance registration message 302a is transferred by the MAG 230, verification of the MN 200 is completed when the MAG(WLAN) 232 receives the binding in-advance registration message 302a transferred by the MAG 230 that has verified the MN 200. In addition, this method also means that the MAG(WLAN) 232 is not required to be notified by the LMA 220 that the MAG(3GPP) 230 is handling the cellular connection 240. The fact that the content of the binding in-advance registration message 302a is transferred by the MAG(3GPP) 230 indicates to the MAG(WLAN) 232 that the MAG(3GPP) 230 is handling the cellular connection 240.

When the MN 200 transmits the binding in-advance registration message 302a to the MAG(WLAN) 232 via the cellular connection 240 of the binding destination will be described with reference to FIG. 13. When the above-described interface switching event 300 is generated, the MN 200 transmits a binding in-advance registration transfer message 304a to the MAG(3GPP) 230 via the cellular connection 240 instead of directly transmitting the binding in-advance registration message 302 to the MAG(WLAN) 232. When the MAG(3GPP) 230 receives the in-advance registration transfer message 304a, the MAG(3GPP) 230 transmits the binding in-advance registration message 302a to the MAG(WLAN) 232. Therefore, because the in-advance registration binding is transmitted to the MAG(WLAN) 232 via the MAG(3GPP) 230, the MAG(WLAN) 232 is not required to verify that the MN 200 has the cellular connection 240. The MAG(WLAN) 232 can also know that the MAG(3GPP) 230 is handling the cellular connection 240. For this purpose, the MAG(3GPP) 230 preferably signs the binding in-advance registration message 302a using an identification key and indicates to the MAG(WLAN) 232 that the binding in-advance registration message 302a is true.

### Fifth Embodiment

### Checking Changed Destination of the Binding Destination

FIG. 13 also shows a variation example of FIG. 5, as an example in which the MN 200 transmits the binding in-advance registration message 302a to the MAG(WLAN) 232 via the cellular connection 240 of the binding destination, and includes a procedure for handing off the cellular connection 240 between the MN 200 and the MAG(3GPP) 230 to the new cellular connection 440 between the MN 200 and the MAG(3GPP) 430. The purpose of resending the in-advance registration binding in FIG. 13 is to update the MAG(WLAN) 232 to become the MAG(3GPP) 430 that is actually handling the connection of the binding destination.

When the MAG(3GPP) 230 is handed off to the MAG(3GPP) 430 (510 in the drawing), the MAG(3GPP) 403 updates the LMA 220 by a PBU message 616. In addition, the MN 200 transmits the binding in-advance registration transfer message 304b to the MAG(3GPP) 430 via the cellular connection 240. When the MAG(3GPP) 430 receives the in-advance registration transfer message 304b, the MAG(3GPP) 403 transmits the binding in-advance registration message 302b to the MAG(WLAN) 232. Here, because the in-advance registration binding of the cellular connection 440 is transmitted to the MAG(WLAN) 232 via the MAG(3GPP) 430, the MAG(WLAN) 232 is not required to verify that the MN 200 has the cellular connection 440. The MAG(WLAN) 232 can also know that the MAG(3GPP) 430 is handling the cellular connection 440. Therefore, even when the WLAN connection 242 is lost, the packets addressed to the MN 200 are transferred to a different cellular connection 440 with minimal delay, without being discarded.

### Sixth Embodiment

### Variations of the In-Advance Registration Binding Trigger

According to the above-described embodiments, it is presumed that the MAG can instantly detect the loss of connection. This is generally true in the layer 2 access technology, and the base station or the access point instantly knows that a mobile station is unrelated. However, there are access technologies and situations in which the MAG cannot instantly know that a mobile station is unrelated. An example is an instance in which the WLAN connection 242 is a Point-To-Point Protocol (PPP) tunnel. This instance occurs when the MN 200 is roaming a non-trusted WLAN access network and sets up a PPP tunnel in an evolved Packet Data Gateway (ePDG) for 3GPP access and to access functions. In this instance, because the access between the MN 200 and the MAG(WLAN) 232 is the PPP tunnel, when the MN 200 loses the WLAN connection 242 with the non-trusted WLAN access network, a certain amount of time is required for the MN 200 to know that it is not positioned in the non-trusted WLAN access network. Under these circumstances, a detected connection loss is useless as a trigger for activating the in-advance registration binding, and other methods are required.

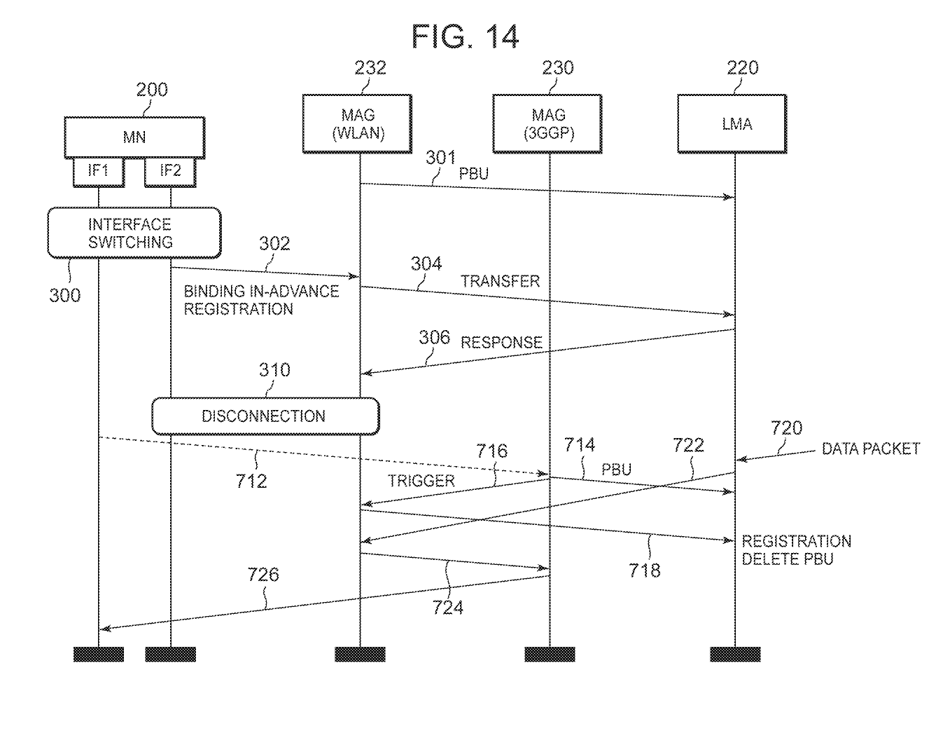

One preferable method is that in which an in-advance binding trigger unit 160 of the MN 200 transmits via the cellular connections 240 and 440, a trigger signal for activating the in-advance registration binding when the interface is disconnected, as shown in FIG. 14. Here, as shown in FIG. 8, the MN 200 has, as two connections, the stable first cellular connection 240 with the MAG(3GPP) 230 and the unstable second WLAN connection 242 that may be a PPP connection via a non-trusted WLAN access network. The PBU message 310, the interface switching event 300, the binding in-advance registration message 302, the transfer message 304, and the response message 306 in FIG. 14 are the same as those in FIG. 8. Therefore, the in-advance registration binding of the cellular connection 204 is registered in both the MAG(WLAN) 232 and the LMA 220, but is still inactive. Therefore, the packets addressed to the MN 200 are continuously transferred via the MAG(WLAN) 232 and the WLAN connection 242. In addition, the MAG 232 is notified that the cellular connection 240 being managed by the MAG 230 by the response message 306 from the LMA 220.

Here, in the switching event 310, the MN 200 has lost the WLAN connection 242 that is the PPP connection via the non-trusted WLAN access network. Therefore, the MAG(WLAN) 232 cannot immediately detect the switching event 310, and only the MN 200 can immediately detect the switching event 310 on the WLAN interface IF2. The MN 200 then transmits to the MAG(3GPP) 230, a binding registration takeover request message 712 requesting that the MAG (3GPP) 230 take over the prefix assigned to the WLAN interface IF2, based on proxy mobile IP. The aspect of the binding registration takeover request message 712 is ordinarily transmitted using layer 2 signaling. However, a person skilled in the art can transmit the binding registration takeover request message 712 using other means, such as a layer 3 Neighbor Solicitation (NS) message or a Dynamic Host Configuration Protocol (DHCP)-based message. In the present invention, a trigger for activating the in-advance registration binding of the cellular connection 240 is further transmitted by the binding registration takeover request message 712.

When the MAG(3GPP) 230 receives the message 712, the MAG(3GPP) 230 transmits to the LMA 220, a PBU message 714 having an appropriate handoff indicator requesting takeover of the prefix of the WLAN connection 242. The MAG(3GPP) 230 also transmits to the MAG(WLAN) 232, a trigger message for activating the in-advance registration binding of the cellular connection 240. Activating the in-advance registration binding of the cellular connection 240 implies that the WLAN connection 242 is no longer used. Therefore, the MAG(WLAN) 232 transmits a registration delete PBU message 718 to the LMA 220. Here, the point at which the in-advance registration binding is activated in the LMA 220 is the point at which the registration delete PBU message 718 is received or the point at which the handoff indicator within the PBU message 714 is received.

The effects thereof will be described using a data packet 720 intercepted by the LMA 220 as an example. The point at which interception occurs is after the disconnection event 310 and before the PBU message 714 of the cellular connection 240 is received. In this situation, the LMA 220 believes that the WLAN connection 242 is still active and tunnels the intercepted data packet 720 within a data packet 722 addressed to the MAG(WLAN) 232. When the MAG(WLAN) 232 receives the data packet 722, the MAG(WLAN) 232 realizes that the in-advance registration binding of the cellular connection 240 has already been activated by the trigger signal 716. Therefore, the MAG(WLAN) 232 transmits the data packet 722 to the MAG(3GPP) 230 by a data packet 724. The MAG(3GPP) 230 transfers the data packet 724 to the MN 200 by a data packet 726.

As described above, the MN 200 uses the active cellular connection 240 and activates the in-advance registration binding of the cellular connection 240 in the MAG(WLAN) 232. In a similar manner, when the MAG(3GPP) 230 transmits the trigger signal 716 to the MAG(WLAN) 232, the same trigger (the PBU message 714 of the cellular connection 240) is transmitted to the LMA 220. Therefore, even when the WLAN connection 242 is lost, the packets addressed to the MN 200 are transferred to the cellular connection 240 with minimal delay, without being discarded, according to the present embodiment as well.

<Trigger Message>

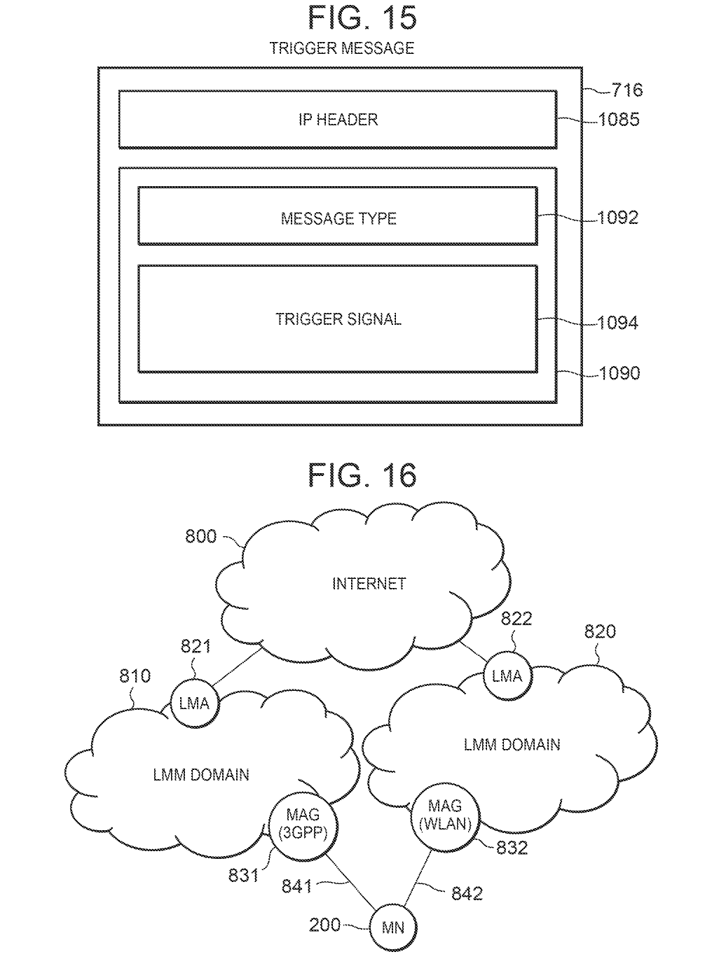

FIG. 15 shows an example of a format of the trigger message 716. The trigger message 716 is used to activate the in-advance registration binding registered in the MAG(WLAN) 232 of the binding source. The trigger message 716 includes an IP header 1085 when the message 716 uses IP. An actual message 1090 follows the IP header 1085. When the message 716 is transmitted via the layer 2 mechanism, the IP header 1085 is replaced by an appropriate layer 2 frame header. The actual message 1090 includes a message type 1092 and a trigger signal field 1094. The message type 1092 indicates that the message is the trigger message 716. The trigger signal field 1094 indicates the in-advance registration binding to be activated.

### Seventh Embodiment

### When the Domain to which the Interface Connects Differs

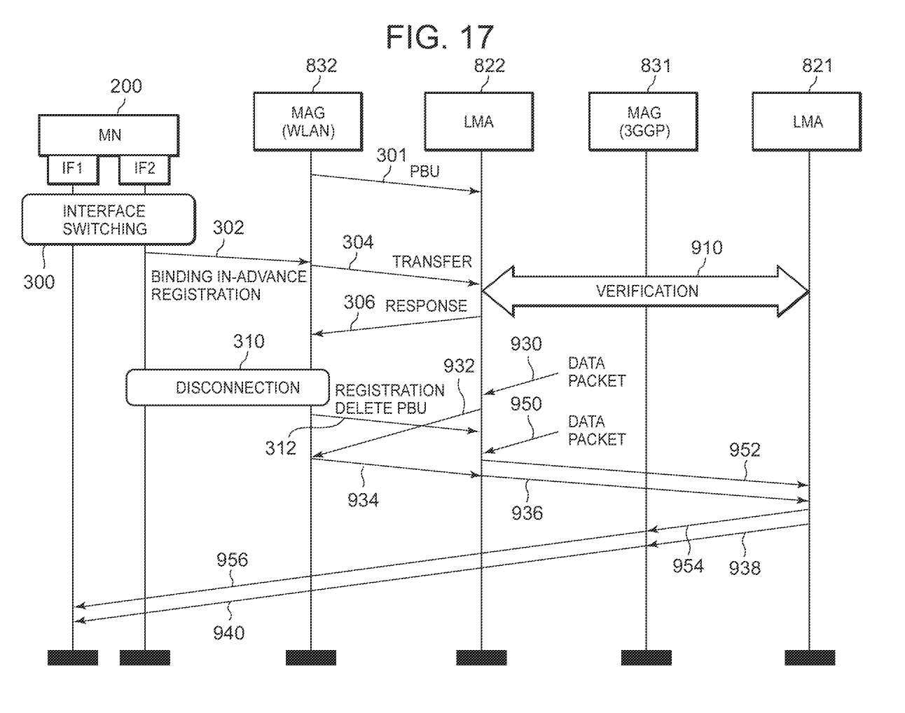

According to all of the above-described embodiments, the binding in-advance registration of the cellular connection 240 is transmitted to the LMA 220 that is a local mobility anchor point. Therefore, this is useful in that the LMA 220 can redirect a received packet to the cellular connection 240 before receiving the PBU message 714 for handoff, thereby preventing unnecessary delay. Next, a seventh embodiment will be described with reference to FIG. 16 and FIG. 17. According to the seventh embodiment, the 3GPP interface IF1 and the WLAN interface IF2 of the MN 200 are respectively attached to different LMM domains 810 and 820.

In FIG. 16, the MN 200 roams within two different LMM domains 810 and 820. The LMM domains 810 and 820 are connected to a global internet 800. The LMM 810 has an LMA 821 and a MAG (3GPP) 831, and the 3GPP interface IF1 of the MN 200 has established a cellular connection 841 with the MAG (3GPP) 831. The LMM domain 820 has an LMA 822 and a MAG (WLAN) 832, and the WLAN interface IF2 of the MN 200 has established a WLAN connection 842 with the MAG (WLAN) 832. The LMA 821 and 822 are connected to the internet 800.

As described above, because the WLAN connection 842 has a wider bandwidth and lower communication cost than the cellular connection 841, the MN 200 desires packet routing via the WLAN connection 842. However, compared to the cellular access network, the WLAN access network has a narrower communication range, and the communication range is scattered. Therefore, according to the present embodiment as well, a seamless handover is actualized from WLAN connection 842 to cellular connection 841 spanning the domains 820 and 821, with minimal packet loss and delay. Herein as well, the cellular connection 841 and the WLAN connection 842 are simply used for the description, and it is clear that other connections may be used.

FIG. 17 shows a communication sequence according to the seventh embodiment. In a manner similar to that according to the first embodiment, when the interface switching event 300 is generated during communication with the MAG(WLAN) 832, the MN 200 transmits the binding in-advance registration message 302 to the MAG(WLAN) 832 via the WLAN connection 842. The binding in-advance registration message 302 includes the desire the MN 200 to establish the cellular connection 841 in place of the current binding in the WLAN connection 842. In addition, when the MAG (WLAN) 832 receives the binding in-advance registration message 302, the MAG (WLAN) 832 transfers the content to the LMA 822 by a transfer message 304. Here, when the LMA 822 handles both the WLAN connection 842 and the cellular connection 841 written within the transfer message 304, the LMA 822 transmits the response message 306 in a manner similar to that according to the second embodiment. However, in this example, because the prefix related to the cellular connection 841 does not belong to the LMM domain 820, the LMA 822 knows that it is not handling the cellular connection 841.

The LMA 822 then extracts the prefix related to the cellular connection 841. Here, under a presumption that a roaming contract is established between the LMM domains 810 and 820, the LMA 822 can verify that the MN 200 has the cellular connection 841. A verification process 910 is performed by the LMA 822 communicating with an LMA 821 on the LMM domain 810 side (binding destination). The verification process 910 is also performed via AAA entities (not shown) within the LMM domains 810 and 820. When the LMA 822 verifies that the MN 200 has the cellular connection 841, the LMA 822 transmits the response message 306 to the MAG (WLAN) 832. Through the response message 306, the LMA 822 notifies the MAG (WLAN) 832 that the cellular connection 841 is handled not by the LMA 821 of the binding destination but by the LMA 822 itself of the binding source.

The cellular connection 841 is not handled by the LMA 821 of the binding destination for a number of reasons. A first reason is that, under most roaming contracts between domains, communication is permitted only between selected entities. Therefore, the MAG (WLAN) 832 of the binding source may not be able to directly transmit a packet to the MAG(3GPP) 831 of the binding destination. Here, only the LMA 822 of the binding source has established security measures for communicating with the LMA 821 of the binding destination. Therefore, when the in-advance registration binding of the cellular connection 841 is activated, the packet is transferred to the LMA 822 of the binding source. A second reason is related to location privacy. Therefore, the LMA 822 itself of the binding source does not know which MAG within the domain 810 of the binding destination is handling the cellular connection 841. A third reason is that, ordinarily, the LMA is an entry and exit point of the LMM domain. Therefore, packets transmitted outside from the domain 820 of the binding source are required to pass through the LMA 822 of the binding source, and packets transmitted into the domain 810 of the binding destination are required to pass through the LMA 821 of the binding destination. Therefore, regarding the route of the packets, there is no advantage in notifying the MAG(WLAN) 832 and the LMA 822 of the binding source, of the MAG supporting the cellular connection 841 at the binding destination.

A temporary binding is registered in the MAG (WLAN) 832 and the LMA 822 of the binding source after the above-described signaling, but is still inactive. Therefore, the packets addressed to the MN 200 are continuously transferred via the MAG (WLAN) 832 and the WLAN connection 842. This transfer via WLAN is continued until the WLAN connection 842 is disconnected (310 in the drawing). When the MAG(WLAN) 832 detects the disconnection 310 of the WLAN connection 842, the MAG(WLAN) 832 transmits the registration delete PBU message 312 of the WLAN connection 842 to the LMA 220 by proxy mobile IP to activate the in-advance registration binding of the cellular connection 841. When the LMA 220 receives the registration delete PBU message 312, the LMA 220 deletes the binding registration (the content of the PBU message 301) of the prefix allocated to the WLAN interface IF2 from the MAG (WLAN) 832, and activates the in-advance registration binding of the cellular connection 841.

FIG. 17 shows that two types of data packets 930 and 950 addressed to the MN 200 are received by the LMA 822. A first data packet 930 is received by the LMA 822 before the registration delete PBU message 312 of the WLAN connection 842. Therefore, the LMA 822 transfers the data packet 930 to the MAG (WLAN) 832 by a data packet 932. Here, the MAG (WLAN) 832 returns the data packet 932 to the LMA 822 of the binding source by a data packet 934 because the in-advance registration binding of the cellular connection 841 has already been activated, and because the in-advance registration binding in the table 130b of the MAG (WLAN) 832 indicates that “the LMA 822 handles the cellular connection 841”. The LMA 822 of the binding source transfers the data packet 934 to the LMA 821 of the binding destination by a data packet 936. The data packet 936 is tunneled within a data packet 938 addressed to the MAG (3GPP) 831 of the binding destination. Ultimately, the MAG (3GPP) 831 transfers the data packet 938 to the MN 200 by a data packet 940 via the cellular connection 841.

A second data packet 950 is received by the LMA 822 after the registration delete PBU message 312 of the WLAN connection 842. Therefore, the LMA 822 transfers the data packet 950 to the LMA 821 of the binding destination by a data packet 952, because the in-advance registration binding of the cellular connection 841 has already been activated by the registration delete PBU message 312. The data packet 950 is tunneled within a data packet 954 addressed to the MAG(3GPP) 831 of the binding destination. Ultimately, the MAG(3GPP) 831 transfers the data packet 954 to the MN 200 by a data packet 956 via the cellular connection 841. Therefore, even when the WLAN connection 832 is lost, the packets addressed to the MN 200 are transferred to a different cellular connection 841 with minimal delay, without being discarded, according to the present embodiment as well.

### Eighth Embodiment

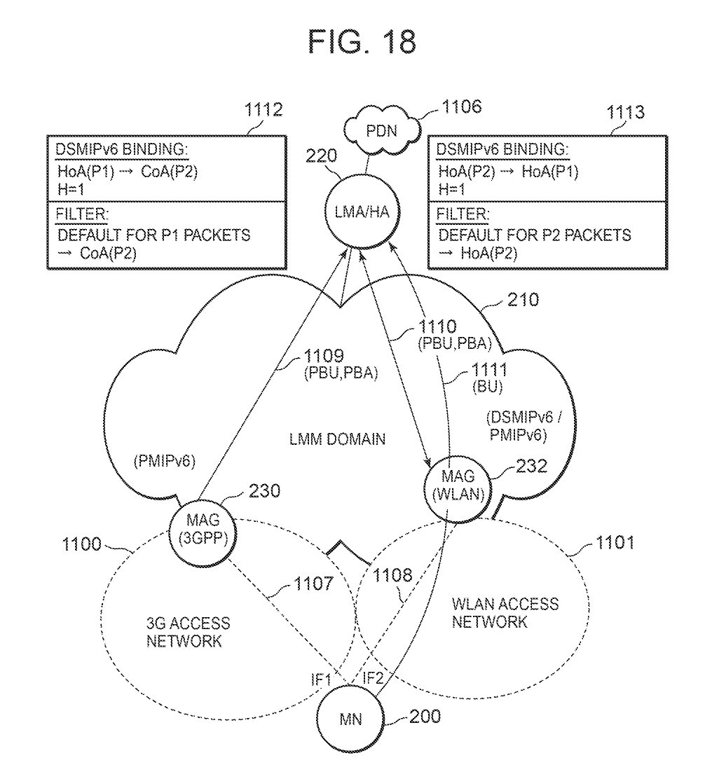

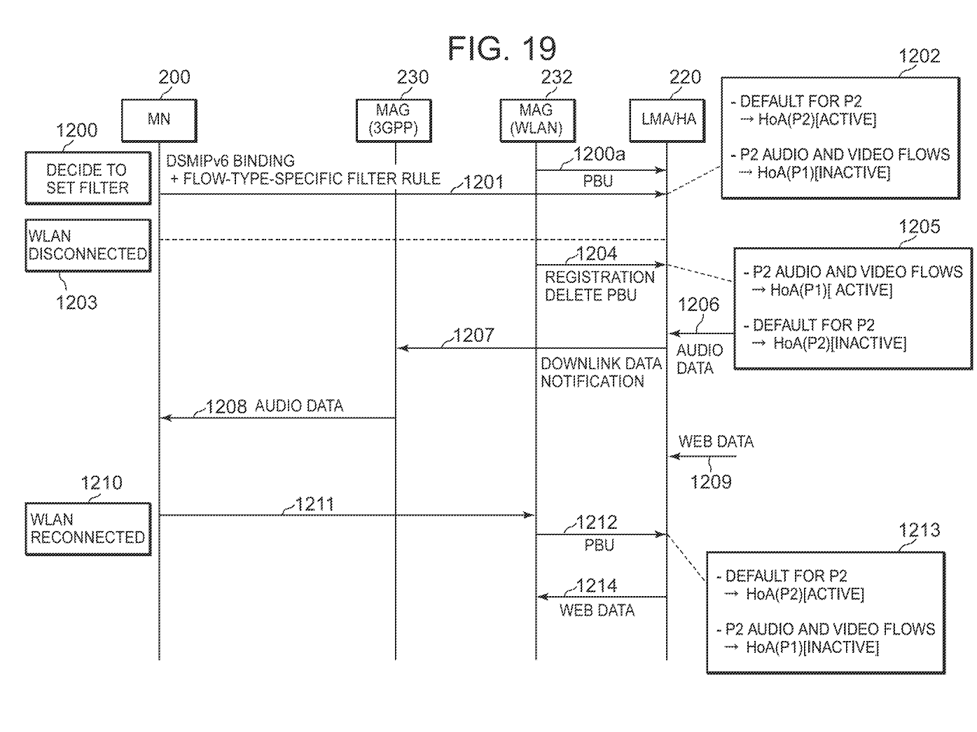

Next, an eighth embodiment will be described in detail with reference to FIG. 18 and FIG. 19. According to the eighth embodiment, when the MN 200 loses a connection via an unstable access (WLAN access network 1101), the MN 200 sets in the LMA/HA 220, an in-advance registration filter rule specifying the type of flow of which the transfer destination is to be switched to the 3GPP access, to reduce packet loss by flow type. Furthermore, according to the eighth embodiment, the MN 200 decides the necessity of establishing the in-advance registration filter rule and transmits a filter rule in-advance registration message. The configuration shown in FIG. 18 has already been described in “Background Art”. Therefore, a detailed description thereof will be omitted. The 3GPP access network 1100 and the WLAN access network 1101 may be of any type as long as the access type can be used in wireless communication, such as 3GPP, WLAN, and WiMAX. For example, the use of WiMAX instead of WLAN can be considered.

FIG. 19 shows a communication sequence for setting the above-described flow-type-specific in-advance registration filter rule. In the scenario according to the eighth embodiment, an instance in which the above-described in-advance registration filter rule is set is when the MN 200 first has a connection established via the unstable WLAN access in active mode and a connection established by the stable 3GPP access in idle mode. Furthermore, when the MN 200 then loses connectivity via the unstable WLAN access, the connection via the stable 3GPP access is switched to active mode.

(1) In FIG. 19, the MN 200 has the 3GPP interface IF1 and the WLAN interface IF2. In addition, the MN 200 is connected in active mode via the unstable WLAN access and connected in idle mode via the stable 3GPP access. The MAG (WLAN) 232 manages the unstable WLAN access (refer to a PBU message 1200a), and the MAG(3GPP) 230 manages the stable 3GPP access. In the 3GPP architecture, the MAG 232(WLAN) is an evolved Packet Data network Gateway (ePDG), and the MAG 230 (2GPP) is a Serving GateWay (S-GW). Furthermore, mobility of the MN 200 is managed by the LMA/HA 220. In the 3GPP architecture, the LMA/HA 220 is a Packet data network GateWay (P-GW), and the MN 200 is a User Equipment (UE).

(2) Here, the MN 200 decides to perform a home and away registration in the LMA/HA 220 after bootstrapping with the LMA/HA 220. Furthermore, the MN 200 registers in the LMA/HA 220 in advance, the home and away registration (H=1) and a filter rule by flow type. Step 1200 in FIG. 19 indicates a deciding process, and a signaling message 1201 indicates the registration message. The content of the signaling message 1201 includes the home and away registration (H=1) for the provided HoA, the current filter rule, and the flow-type-specific filter rule (in-advance registration filter rule) to be used during a future disconnection period of the connection via the unstable WLAN access.

(3) After the MN 200 creates one or a plurality of HoA for each interface IF1 and IF2, the MN 200 decides to set the current filter rule at Step 1200. Here, the MN 200 uses a filter rule stating the desire for all flows, such as audio flows, video flows, and data flows, identified by a plurality of FID to be transmitted via only the unstable WLAN access (default for P2→HoA(P2)) even when the home and away registration (H=1) via both interfaces IF1 and IF2 is performed. At Step S1200, the MN 200 decides to register in advance, a flow-type-specific filter rule activated at disconnection of the connection via the unstable WLAN access, in addition to the currently active filter rule (here, a filter rule is used stating the desire for the audio and video flows of P2 to be transmitted via the 3GPP access (P2 audio flow and P2 video flow→HoA(P1)). The flow-type-specific in-advance registration filter rule is not active when notification is given to the LMA/HA 220 and is activated at disconnection of the connection via the unstable WLAN access.

The reason that notification of the flow-type-specific in-advance registration filter rules is given is because a trigger is required to give priority to the in-advance registration filter rule over the current filter rule, at disconnection of the connection via the unstable WLAN access. As a result of the trigger, the in-advance registration filter rule is used preferentially over the current filter rule during disconnection of the connection via the unstable WLAN access. If the in-advance registration filter rule is not set, packet loss occurs in the LMA/HA 220. The reason is because the LMA/HA 220 judges that an effective routing state giving an instruction for routing via the stable 3GPP access is not present. In this instance, the LMA/HA 220 buffers the packets of all flows until the connection via the unstable WLAN access is set up again. The packets may be discarded due to overflow of the buffer after the elapse of a certain amount of time. Alternatively, the packets may be discarded without being buffered. Such problems occur because, when the filter rule is once set, the LMA/HA 220 adheres to filter-rule-based routing. A main reason for the problem is that the LMA/HA 220 does not have an accurate filter management procedure during disconnection via the unstable WLAN access. Therefore, the in-advance registration filter rule is required. Basically, the in-advance filter rule notifies the LMA/HA 220 of the filter management rule during a period in which the MN 220 has lost connectivity via the unstable WLAN access.

When focus is placed as described above, buffering is performed when the packets cannot be routed during disconnection. However, this buffering is not preferable for real-time flows (audio flows and video flows). In addition, although buffering is acceptable for non-real-time flows (data flows), buffering should be prevented for time-critical real-time flows because delay and jittering become increased.

The MN 200 decides or predicts that the flow-type-specific in-advance registration filter rule is required in advance, and decides to transmit the flow-type-specific in-advance registration filter rule with the currently effective filter rule. A characteristic of the in-advance registration filter rule is that the boundaries of the activation point are defined. The in-advance registration filter rule is required to be active only during disconnection of the unstable WLAN access. The in-advance registration filter rule is also characteristic in that it has a higher priority level than the current filter rule during the active period, but the current filter rule is not deleted. The in-advance registration filter rule becomes inactive after the active period and is used again (activated) during subsequent disconnections of the unstable WLAN access. In the deciding process at Step 1200, the MN 200 decides that the in-advance registration filter rule is necessary, and decides that the in-advance registration filter rule is required to be retained in the LMA/HA 220 even during a long period after the active period.

A reason for which the MN 200 decides that the flow-type-specific in-advance registration filter rule is necessary may be that the MN 200 has a type of flow (a real-time flow such as a video flow and an audio flow) requiring prevention of packet loss and improvement of QoS, via the unstable WLAN access. In addition, the MN 200 may have network-provided information indicating that a plurality of disconnection events will likely occur during session periods related to the above-described type of flow. In this instance, the LMA/HA 220 is required to retain the in-advance registration filter rule for a plurality of disconnection event periods. Furthermore, the MN 200 predicts that a stable connection via 3GPP access can be used in the LMM domain 210 and that the in-advance registration filter rule can be retained during the periods of the plurality of disconnection events, based on information from a certain server, such as an Access Network Discovery Selection Function (ANDSF) or information collected by the MN 200. In addition, the MN 200 predicts that a stable interface access technology policy and a stable interface access system is preferable for transferring the flow related to the unstable interface during disconnection based on ANDSF information and/or its own measurement information, and thus the in-advance registration filter rule is held in the LMA/HA 220.

Next, a structure of the signaling message 1201 will be described. Here, the MN 200 has two home addresses HoA(P1) and HoA(P2). The HoA(P2) is configured by a prefix P2 acquired via PMIPv6 mobility signaling 1110 from the MAG(WLAN) 232 to the LMA/HA 220. The HoA(P1) is configured by a prefix P1 acquired via PMIPv6 mobility signaling 1109 from the MAG(3GPP) 230 to the LMA/HA 220. After the MN 200 uses the DSMIPv6 bootstrapping procedure to acquire the HoA(P1) and HoA(P2), first, the MN 200 generates the home and away registration (H=1) for the HoA(P2) configured by the prefix P2. The MN 200 binds the HoA(P1) configured by the prefix P1 to the HoA(P2) as the CoA and further adds a flag H to the binding, to obtain the advantages of multihoming by home and away registration for flows addressed to an address related to the prefix P2.

In addition to the simultaneous establishment of paths for the HoA(P2) related to the prefix P2, the MN 200 desires the use of WLAN access when possible and creates the current filter rule stating that “the WLAN access is the default, or in other words, the preferred access for flows related to the prefix P2”. The MN 200 includes an FID option with a sub-option stating the appropriate flow, and gives notification that all flows described in the FID should be delivered via the WLAN access. Therefore, the MN 200 creates a signaling message 1201 including home and away semantics, the current filter rule, and the in-advance registration filter rule. Here, the signaling message 1201 is a DSMIPv6 BU message including the current filter rule and the in-advance registration filter rule embedded as addition mobility options.

The signaling message 1201 for transmitting the in-advance registration filter rule (and a signaling message 1305 for transmitting a in-advance registration blocking filter rule according to a ninth embodiment described hereafter) may, for example, have a configuration similar to that of the binding in-advance registration message shown in FIG. 6. In this instance, the message type 1012 shown in FIG. 6 indicates that the message is a message including the in-advance registration filter rule (in-advance registration blocking filter rule). The binding destination 1014 includes the in-advance registration filter rule (in-advance registration blocking filter rule) itself.

The flow-type-specific in-advance registration filter rule embedded in the signaling message 1201 by the MN 200 is that, when the MN 200 disconnects the unstable WLAN access, the audio flows and the video flows identified by a number of FID are required to be transmitted to the address related to the prefix P1. The signaling message 1201 further has a trigger related to the activation point and the deactivation point of the in-advance registration filter rule. The flow-type-specific in-advance registration filter rule is activated when the PMIPv6 binding registration of the unstable WLAN access is deleted and deactivated when the PMIPv6 binding registration via the unstable connection, or in other words, the WLAN access is reestablished.

In some instances, to activate and deactivate the in-advance registration filter rule, an activation message and a deactivation message that are both explicit (neither are associated with the PBU message) can be transmitted to the LMA/HA 220 from the MN 200, and the MAG(WLAN) 232 or the MAG(3GPP) 230. Therefore, activation and deactivation triggers that clearly indicate the type of signaling to be used to activate and deactivate the in-advance registration filter rule are useful. As a message describing the type of message that activates and deactivates the in-advance registration filter rule, the message described in FIG. 6 can be used. Here, it is postulated that the same prefix P2 is allocated when the MN 200 reconnects via the unstable access.

(4) In FIG. 19, after the DSMIPv6 signaling is constructed by the home and away registration, the current filter rule, and the in-advance registration filter rule, the constructed DSMIPv6-based signaling message 1201 is transmitted to the LMA/HA 220. As a result of the signaling message 1201, the current filter rule and the flow-type-specific filter rule that is triggered later are generated in the LMA/HA 220. The current filter rule and the in-advance registration filter rule are individually retained. When the LMA/HA 220 receives the signaling message 1201, in addition to holding the binding, the LMA/HA 220 holds the current filter rule (default for P2→HoA(P2)) as active and holds the flow-type-specific in-advance registration filter rule (P2 audio and video flows→HoA(P1)) as inactive as indicated in state 1202, and holds a rule for activating and deactivating the in-advance registration filter rule.

As a scenario other than the scenario in which the MN 200 creates the two home addresses HoA(P1) and HoA(P2), a scenario can be considered in which the MN 200 creates the HoA(P1) using only the prefix P1, and establishes the home and away registration for the CoA(P2) created for the unstable WLAN interface IF2 from the prefix P2. At this time, when the current filter rule is established in the LMA/HA 220, all flows related to the prefix P2 are transmitted via the WLAN access as indicated in state 1202.

(5) Next, the MN 200 loses connection via the unstable WLAN access (event 1203). When the MN 200 loses this unstable connection, the MAG (WLAN) 232 detects the disconnection and transmits to the LMA/HA 220, a registration delete PBU message 1204 for deleting the PBU registration related to the prefix P2. When the LMA/HA 220 receives the PBU registration delete message 1204, the LMA/HA 220 checks the rule for activating the flow-type-specific in-advance registration filter rule. Based on the activation rule, because the PBU registration related to the prefix P2 is deleted, the LMA/HA 220 activates the in-advance registration filter rule. When the in-advance registration filter rule is activated, the LMA/HA 220 changes the state in the filter maintenance table from state 1202 to state 1205. In state 1205, the current filter rule transitions to inactive mode and the in-advance registration filter rule transitions to active mode.

The important point here is that the current filter rule is not removed even when the flow-type-specific in-advance registration filter rule is activated. As a result, even when the MN 200 reconnects via the unstable WLAN access, the MN 200 does not need to reregister the old (current) filter rule. A characteristic of the flow-type-specific in-advance registration filter rule is that the flow-type-specific in-advance registration filter rule is given priority over the old (current) filter rule until the old (current) filter rule is reactivated when the MN 200 reestablishes connection via the unstable WLAN access. When the LMA/HA 220 receives the registration delete PBU message 1204, the LMA/HA 220 returns a PBA message (not shown) related to the prefix P1 to the MAG(WLAN) 232.

(6) Next, audio data 1206 reaches the LMA/HA 220 after disconnection of the connection via the unstable WLAN access. Because the audio flow is transferred via the stable 3GPP access based on the in-advance registration filter rule in the LMA/HA 220 as indicated in the state 1205, the LMA/HA 220 transmits a downlink notification message 1207 to the MAG(3GPP) 230. Here, because the 3GPP interface IF1 of the MN 200 is in idle mode, the downlink notification message 1207 is transmitted from the LMA/HA 220. The MAG230 (3GPP) 230 is the S-GW in the 3GPP architecture and notifies the MME (not shown) of the arrival of the audio packet. The MME calls the MN 200 and makes the MN 200 transmit a service request message (not shown). When the MME receives the service request message, the MME notifies the MAG230 (3GPP) 230 to switch the 3G interface IF1 of the MN 200 to active mode. As a result of this operation, the MN 200 receives an audio data packet 1208 from the MAG230 (3GPP) 230. Therefore, as a result of the in-advance registration filter rule being activated, when the disconnection of the unstable WLAN access is detected by the LMA/HA 220, audio traffic of which delay becomes a problem immediately reaches the MN 200. Therefore, because the in-advance registration filter rule is triggered at the most appropriate time, the problem of packet loss can be solved for audio traffic of which delay becomes a problem.

(7) Next, Web data 1209 addressed to an address related to the prefix P2 reaches the LMA/HA 220 during disconnection of the unstable WLAN access. The Web data 1209 cannot be routed to the MN 200. The reason is because the transmission destination of the Web data 1209 is not indicated in the in-advance registration filter rule, as indicated in state 1205, and adheres to the current filter rule. The Web data 1209 that reaches the LMA/HA 220 may be buffered in the LMA/HA 220.

(8) Next, after the elapse of a certain amount of time, the MN 200 rediscovers the unstable WLAN access and reconnects thereto (Step 1210). In this instance, the MN 200 transmits to the MAG (WLAN) 232, a signaling (reconnection signaling) 1211 for reconnection and reattaches to the MAG (WLAN) 232. The MAG (WLAN) 232 then transmits a PBU message 1212 to the LMA/HA 220. The MN 200 may include the prefix P2 that the MN 200 wishes to use after reconnection in the signaling 1211. Here, the MAG (WLAN) 232 to which the MN 200 reattaches is not necessarily the same MAG(WLAN) 232 that previously had the connection. The PBU message 1212 requests the allocation of the prefix P2 by having the home network prefix option including the prefix P2. Here, because the MN 200 has created the home address HoA(P2) from the prefix P2, the LMA/HA 220 likely provides the same prefix P2 by the PBA message (not shown) that is the response.

(9) When the LMA/HA 220 receives the PBU message 1212, the LMA/HA 220 deactivates the in-advance registration filter rule and activates the old filter rule, as indicated in state 1213. The flow-type-specific in-advance registration filter rule indicating transmission of the audio flows and the video flows via the 3GPP access is deactivated, and the old filter rule indicating transmission of all flows via the WLAN access is activated. The content of the state 1213 generated in the LMA/HA 220 after the LMA/HA 220 receives the PBU message 1212 is the same as the original state 1202, and the original filter rule is activated even without the MN 200 transmitting an explicit filter rule signaling. The reason is because the flow-type-specific in-advance registration filter rule has a high priority level during disconnection of the connection via the unstable WLAN access and the current (old) filter rule is not deleted. When the original filter rule is established, the Web data 1214 buffered in the LMA/HA 220 is transmitted to the MAG(WLAN) 232.

The flow-type-specific in-advance registration filter rule according to the present embodiment can also be applied to when the MN 200 is connected to the LMM domain 21 via all interfaces IF1 and IF2 in active mode, and one or a plurality of connections via the unstable WLAN access is lost. For example, the flow-type-specific in-advance registration filter rule can be applied to a scenario in which the MN 200 may have an active connection via the stable 3GPP access and an active connection via the unstable WLAN access, and subsequently loses the connection via the unstable WLAN access. Furthermore, the flow-type-specific in-advance registration filter rule according to the present embodiment can be applied to when the MN 200 connected to the 3GPP access in active mode disconnects the connection to the 3GPP access when connecting the WLAN access, and switches the interface to be used for communication from the 3GPP interface to the WLAN interface.

As another scenario for establishing the in-advance registration filter rule, an instance is postulated in which the MN 200 is connected to the LMM domain 21 via two active mode interfaces in active mode, and performs an Inter Radio Access Technology handoff or a Vertical Handoff from a certain connected interface to a third interface that is newly turned ON. For example, the MN 200 is first connected to the LMM domain 21 via the 3GPP interface IF1 and a WiMAX (registered trademark) interface IF3. Next, the MN 200 discovers the WLAN access and performs a vertical handoff from WiMAX to WLAN to actualize wider bandwidth, lower cost, or better QoS via the WLAN interface IF2. In this scenario, to prevent packet loss of the flow addressed to the WiMAX interface IF3 that is in the process of performing the vertical handoff, the MN 200 may be required to set a flow-type-specific in-advance registration filter rule.

<Variations of Filter Rule In-Advance Registration Message>

In the signaling message 1201 in FIG. 19, notification of the flow-type-specific in-advance registration filter rule can be given using a flag. This flag-based method of giving notification of the flow-type-specific in-advance registration filter rule is a variation of the method of explicitly giving notification of the flow-type-specific in-advance registration filter rule. The flag notifies the LMA/HA 220 to transmit all real-time flows (audio and video) via the stable 3GPP access. According to the method using the flag, the in-advance registration filter rule is not required to be explicitly embedded within the signaling message 1201. When the unstable WLAN access connection is disconnected, a flag within a DSMIPv6 BU message notifies the LMA/HA 220 to transmit all real-time flows (audio and video) via the stable 3GPP access. Here, the above-described filter information may be transmitted by a new mobility option, in place of the flag. When the real-time flows are transmitted via the stable 3GPP access and the unstable WLAN access connection is reestablished, the old filter rule is reactivated.

As a variation example, the above-described flag can instruct the LMA/HA 220 to generate and retain the flow-type-specific in-advance registration filter rule. The LMA/HA 220 can generate an appropriate flow-type-specific in-advance registration filter rule based on the instruction, and can use the in-advance registration filter rule every time the unstable WLAN access connection is disconnected. The method of using a flag to give an instruction to generate and retain the in-advance registration filter rule can reduce the signaling cost related to the in-advance registration filter rule.

### Ninth Embodiment

According to a ninth embodiment, the difference between FIG. 18 and FIG. 19 is that the MN 200 does not perform the home and way registration (H=1) in the LMA/HA 220. Here, according to the ninth embodiment, in addition to the PMIPv6 binding for binding the prefix P2 with the address of the MAG (WLAN), an in-advance registration binding for binding the prefix P2 with the prefix P1 and a flow-type-specific in-advance registration blocking filter rule serving as the in-advance registration filter rule are simultaneously established in the LMA/HA 220. A characteristic of the in-advance registration blocking filter rule is that the in-advance registration blocking filter rule is inactive until activated, and blocks (prohibits) delivery of a predetermined type of flow (data flow, herein) via the stable 3GPP access based on the in-advance registration binding (P2→P1) during the active period. The reason for applying the in-advance registration blocking filter rule is because of a postulation that, when the connection via the unstable WLAN access is disconnected, the MN 200 does not wish for delivery of non-time-critical flows/non-real-time flows via the stable 3GPP access of which the bandwidth should be secured.

As a result of using the in-advance registration blocking filter rule such as this, when the connection via the unstable WLAN access is disconnected, the MN 200 can buffer non-time-critical flows rather than transferring the flows to the 3GPP access. The in-advance registration blocking filter rule has a higher priority level than the in-advance registration binding, and overwrites the in-advance registration binding rule regarding flows defined in the in-advance registration blocking filter rule. Furthermore, the MN 200 sets the in-advance registration blocking filter rule in advance and performs setting such as to be triggered at an optimal time, in a manner similar to that of the in-advance registration filter rule described according to the eighth embodiment. The in-advance registration blocking filter rule is deactivated after the elapse of the active period until the connection via the unstable WLAN access is disconnected again. The active period of the in-advance registration blocking filter rule is the period during which the connection via the unstable WLAN access is disconnected.

Even in an instance in which the MN 200 has set no filter rules in the LMA/HA 220, the method of simultaneously transmitting the in-advance registration filter rule (P2→P1) and the in-advance registration blocking filter rule to the LMA/HA 220 and simultaneously triggering the filter rules can be applied. In this instance, during the period in which the connection via the unstable WLAN access is disconnected, the MN 200 makes the LMA/HA 220 transfer time-critical flows (audio and video flows) via the stable 3GPP access based on the in-advance registration binding (P2→P1) and blocks other non-time-critical flows based on the in-advance registration blocking filter rule. The in-advance registration blocking filter rule is given priority over the in-advance registration binding (P2→P1) during the active period.

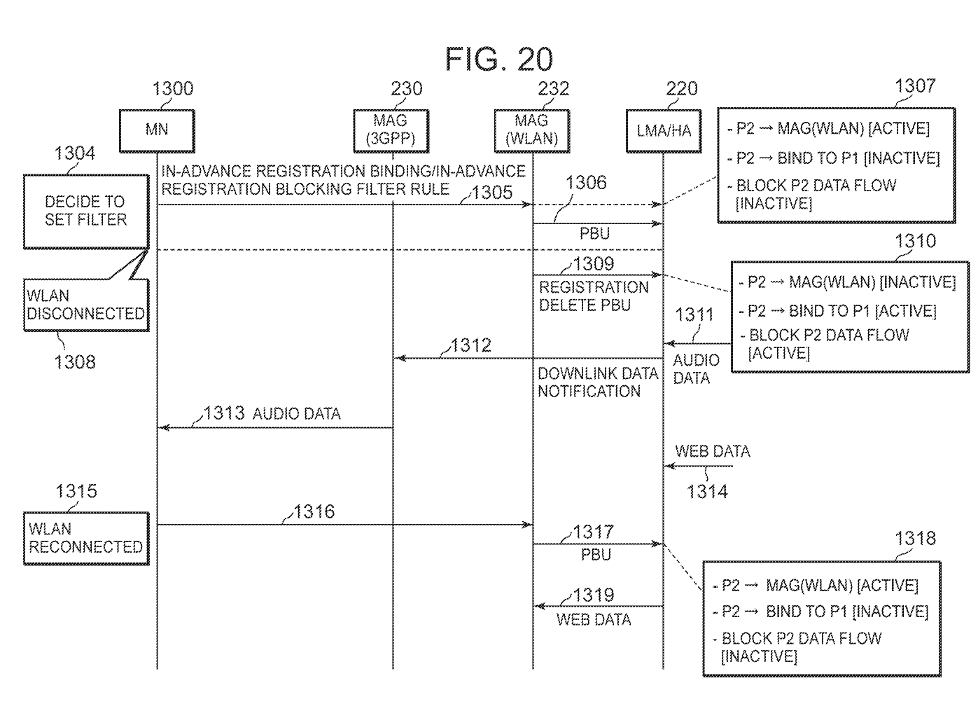

Next, operations and communication sequence according to the ninth embodiment will be described with reference to FIG. 20. Because the network configuration of the communication sequence shown in FIG. 20 is the same as that in FIG. 18, detailed descriptions thereof will be omitted. Here, the MN 200 does not perform the home and away registration (H=1) in the LMA/HA 220 such as that according to the eighth embodiment. The MN 200 first sets up the flow using the prefix P2 referenced via the unstable WLAN access and then performs flow-type-specific routing when the connection via the unstable WLAN access is disconnected. In addition, the prefix P2 is referenced via the stable 3GPP access.

(1) The MN 200 first predicts the necessity of the in-advance registration binding and the in-advance registration blocking filter rule at Step 1304. In other words, because the MN 200 knows that the home and away registration (H=1) related to the flows related to the prefix P2 is not performed in the LMA/HA 220, the MN 200 predicts that the in-advance registration binding (P2→P1) is required to bind the P2 to the P1 to prevent packet loss in time-critical flows when the connection via the unstable WLAN access is disconnected. However, regarding non-time-critical traffic (such as Web traffic), the MN 200 does not desire transfer to the stable 3GPP even when the connection via the unstable WLAN access is disconnected and decides to transmit the in-advance registration blocking filter rule for blocking the transfer.

(2) After the decision, the MN 200 transmits the in-advance registration binding (P2→P1) and the in-advance registration blocking filter rule by a signaling message 1305 to the LMA/HA 220. The message 1305 can be transmitted to the LMA/HA 220 as indicated by the broken lines when the MN 200 has already performed a binding registration in the LMA/HA 220. Otherwise, the MN 200 can transmit the message 1305 via the MAG (WLAN) 232. The message 1305 via the MAG (WLAN) 232 can be transmitted as a layer 2 message from the MN 200 to the MAG (WLAN) 232. Furthermore, the in-advance registration binding (P2→P1) and the in-advance registration blocking filter rule can be transmitted from the MAG (WLAN) 232 to the LMA/HA 220 by a PBU message 1306. When the in-advance registration binding (P2→P1) and the in-advance registration blocking filter rule are transmitted to the LMA/HA 220 by the PBU message 1306, the in-advance registration binding (P2→P1) and the in-advance registration blocking filter rule are transmitted using a new mobility option.

The messages 1305 and 1306 have the in-advance registration binding for binding the prefix P2 to the prefix P1 and the in-advance registration blocking filter rule for blocking transfer of data flow via the 3G access during disconnection of an unstable access. The PBU message 1306 also generates a PMIPv6 binding for the prefix P2. When the in-advance registration binding and the in-advance registration blocking filter rule are transmitted from the MAG (WLAN) 232 to the LMA/HA 220 by the PBU message 1306 is described. However, other secure signals between the MAG (WLAN) 232-LMA/HA 220 may be used.

(3) The binding state of the MN 200 is generated in the LMA/HA 220 by the PBU message 1306. Based on state 1307,

ordinary PMIPv6 registration for binding the P2 to the MAG(WLAN) address [active],

in-advance registration binding for binding the P2 to the P1 [inactive], and

in-advance registration blocking filter rule for blocking the P2 data flow [inactive]

are managed. The in-advance registration blocking filter rule may be transmitted by a message 1305 using the ordinary filter procedure. For example, the blocking rule can be identified using the FID within the message 1305, and whether the action related to the FID is to block or to buffer the flow can be identified. A flow description sub-option attached to the above-described FID has a description of the flow required to be blocked.

(4) Next, the MN 200 decides to disconnect association with the WLAN access (event 1308). During this disconnection event 1308, the MAG (WLAN) 232 transmits to the LMA/HA 220, a registration delete PBU message 1309 for deleting the registration by the PBU message 1306. When the LMA/HA 220 receives the registration delete PBU message 1309, the LMA/HA 220 generates state 1310 for managing the in-advance registration binding and the in-advance registration blocking filter rule. Based on state 1310, only the in-advance registration binding that binds the prefix P2 to the prefix P1 and the in-advance registration blocking filter rule for blocking the prefix P2 data flow become active (ordinary PMIPv6 registration becomes inactive).

(5) As a next postulation, audio data 1311 having a destination address related to the prefix P2 reaches the LMA/HA 220 during disconnection of the connection via the WLAN access. In this instance, because the ordinary PMIPv6 registration for the prefix P2 is inactive, the audio data 1311 is routed via the 3GPP path based on the in-advance registration binding that binds the prefix P2 to the prefix P1. At this time, the LMA/HA 220 transmits a downlink data notification message 1312 to the MAG (3GPP) 230. When the MAG (3GPP) 230 receives the audio data, the MAG (3GPP) 230 buffers the audio data until the MME (not shown) gives notification to transfer the audio data via a wireless access network. The MME (not shown) calls the MN 200, and the MN 200 transmits a service request message to the MME (not shown) after receiving the call signal. When the MME (not shown) receives the service request message, the MME (not shown) notifies the MAG (3GPP) 230 to route the audio flow. The MAG (3GPP) 230 then transmits the audio data 1313 to the MN 200.

(6) As a next postulation, Web data 1314 having a destination address related to the prefix P2 reaches the LMA/HA 220 during disconnection of the connection via the WLAN access. In this instance, the Web data 1314 is blocked or buffered in the LMA/HA 220 based on the in-advance registration blocking filter rule for blocking the prefix P2 data flow. Here, if the in-advance registration blocking filter rule is not set, the Web data 1314 is transmitted via the stable 3G access. However, this is not preferable. The important point here is that, because the in-advance registration blocking filter rule is applied to the Web data 1314, the in-advance registration blocking filter rule is given priority over the in-advance registration binding. Therefore, the Web data 1314 is blocked (transfer via the 3G access is prohibited) based on the in-advance registration blocking filter rule.

(7) As a next postulation, after the elapse of a certain amount of time, the MN 200 references the WLAN access network 1101 and starts to reconnect thereto (Step 1315). After Step 1315, the MN 200 transmits an attachment signal 1316 to the MAG (WLAN) 232. The MAG (WLAN) 232 may be an ePDG. When the MAG (WLAN) 232 receives the attachment signal 1316, the MAG (WLAN) 232 transmits a PBU message 1317 to the LMA/HA 220. The PBU message 1317 is a registration request for the prefix P2. As a general presumption, because the in-advance registration binding for binding the prefix P2 to the prefix P1 is present in the LMA/HA 220, the prefix P2 of the PBU message 1317 is provided to the MN 200 by the LMA/HA 220. When the LMA/HA 220 receives the PBU message 1317, the LMA/HA 220 changes the in-advance registration binding and the in-advance registration blocking filter rule to inactive, and the ordinary PMIPv6 registration to active, as shown in state 1318. After the PMIPv6 registration for the prefix P2 is restored, the Web data 1314 that has been buffered in the LMA/HA 220 can be transmitted via the preferred WLAN access, in a similar manner to the Web data 1319.

The preferred embodiments of the present invention are described above. However, it is clear that various modifications can be made without departing from the scope of the present invention. For example, according to the above described embodiments, when the MN 200 registers a single in-advance registration binding is described. However, the MN 200 may register a plurality of in-advance registration bindings. For example, in FIG. 1, the MN 200 can register the in-advance registration binding for binding the WLAN connection 242 to the cellular connection 240 in the MAG(WLAN) 232 and, at the same time, register the in-advance registration binding for binding the cellular connection 240 to the WLAN connection 242 in the MAG(3GPP) 230.

In addition, according to the preferred embodiments, a network-based local mobility management domain is described. However, the present invention can clearly be applied to a local mobility management domain using Hierarchical Mobile IP (HMIP), as well. The present invention can also be applied to when the MN 200 is roaming a domain with no local mobility management.

In the latter instance, the MN 200 is connected to two access routers. The MN 200 uses the present invention and sets up, in a first access router, an in-advance registration binding for binding a first address configured by the MN 200 connecting with the first access router and a second address configured by the MN 200 connecting with a second access router, and the like. The in-advance registration binding and the like are not activated until the first access router detects that connection with the MN 200 is lost, and becomes activated when the first access router detects that the connection with MN 200 is lost. A packet intercepted by the first access router is routed to the second address of the MN 200 via the second access router. Here, it is clear that this method differs from Fast Mobile IPv6 (FMIP). The FMIP binding registration is already activated, but the in-advance registration binding and the like of the present invention are not activated until triggered. Therefore, even when the MN 200 sets up the in-advance registration binding and the like using the present invention, the current connection is continuously used until the current connection is lost. This operation cannot be actualized in FMIP.

Each functional block used in the descriptions of the embodiments of the present invention, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed or a reconfigurable processor of which connections and settings of the circuit cells within the LSI can be reconfigured can be used after LSI manufacturing. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The present invention has an effect of preventing packet loss and enabling transfer of packets to a switched interface with minimal delay when a mobile node having a plurality of interfaces switches an interface to be used. The present invention can be used in a network-based local mobility management network and the like.

In addition, the present invention has an effect of preventing packet loss and enabling transfer of packets to a switched interface by flow type with minimal delay when a mobile node having a plurality of interfaces switches an interface to be used. The present invention can be used in a network supporting a mobile node using each network-based and client-based mobility management protocol.

1. An interface switching system that switches a path between a mobile node having at least first and second interfaces and a mobility management node from a first path via the first interface and a first proxy node to a second path via the second interface and a second proxy node, the interface switching system comprising:
a means for registering, from the first proxy node to the mobility management node, a first transfer information for establishing the first path;
a means for registering in the first proxy node in advance by the mobile node, a second transfer information for establishing the second path, when the mobile node detects a change in a connection state of the first path; and
a means for requesting, by the first proxy node or the mobile node, that the mobility management node invalidate the first transfer information and validate the second transfer information registered in advance, when the first proxy node or the mobile node detects an event that switches from the first path to the second path.

2. The interface switching system according to claim 1, wherein the mobility management node transfers a packet by switching from via the first proxy node to via the second proxy node, after receiving the request for validation of the second transfer information registered in advance.

3. The interface switching system according to claim 1, wherein:
the first proxy node intercepts a packet that is via the first proxy node received from the mobility management node after the message requesting validation of the second transfer information registered in advance has been transferred, and transfers the packet to the second proxy node; and
the second proxy node transfers the transferred packet to the second interface of the mobile node.

4. The interface switching system according to claim 1, wherein the second transfer information is registered in advance via the second proxy node, when the second transfer information for establishing the second path is registered in advance from the mobile node to the first proxy node.

5. The interface switching system according to claim 1, wherein the second transfer information includes a type of flow of which transfer via the second path is permitted, or a type of flow of which transfer via the second path is prohibited.

6. A mobile node in an interface switching system that switches a path between the mobile node having at least first and second interfaces and a mobility management node from a first path via the first interface and a first proxy node to a second path via the second interface and a second proxy node, the mobile node comprising:
a means for registering in the first proxy node in advance, a second transfer information for establishing the second path, when a change in a connection state of the first path is detected during communication via the first path.

7. The mobile node according to claim 6, further comprising:
a means for requesting, from the first proxy node to the mobility management node, invalidation of a first transfer information established for the first path and validation of the second transfer information registered in advance, when an event that switches from the first path to the second path is detected.

8. The mobile node according to claim 6, wherein, the second transfer information is registered in advance via the second proxy node when the second transfer information for establishing the second path is registered in the first proxy node in advance.

9. The mobile node according to claim 6, wherein the second transfer information includes a type of flow of which transfer via the second path is permitted, or a type of flow of which transfer via the second path is prohibited.

10. A proxy node that is a first proxy node in an interface switching system that switches a path between a mobile node having at least first and second interfaces and a mobility management node from a first path via the first interface and the first proxy node to a second path via the second interface and a second proxy node, the proxy node comprising:
a means for requesting that the mobility management node register a first transfer information for establishing the first path;
a means for receiving from the mobile node, a message that registers in advance a second transfer information for establishing the second path;
and a means for requesting that the mobile management node invalidate the first transfer information and validate the second transfer information registered in advance, when an event that switches from the first path to the second path is detected.

11. The proxy node according to claim 10, wherein the proxy node transfers to the mobility management node, content of the second transfer information registered in advance by the mobile node, and requests notification of information on the second proxy node.

12. The proxy node according to claim 10, wherein the proxy node intercepts a packet that is via the first proxy node received from the mobility management node and transfers the packet to the second proxy node, after transmitting to the mobility management node the request for validation of the second transfer information registered in advance.

13. The proxy node according to claim 10, wherein the second transfer information includes a type of flow of which transfer via the second path is permitted, or a type of flow of which transfer via the second path is prohibited.

14. A mobility management node in an interface switching system that switches a path between a mobile node having at least first and second interfaces and the mobility management node from a first path via the first interface and a first proxy node to a second path via the second interface and a second proxy node, the mobility management node comprising:
a means for receiving from the first proxy node, a request to register a first transfer information for establishing the first path, and registering the first transfer information; and
a means for receiving from the first proxy node or the mobile node, a request for invalidation of the first transfer information and validation of a second transfer information for establishing the second path, and invalidating the first transfer information and validating the second transfer information.

15. The mobility management node according to claim 14, wherein, the mobility management node transfers a packet by switching from via the first proxy node to via the second proxy node after receiving the request for validation of the second transfer information registered in advance.

16. The mobility management node according to claim 14, wherein the second transfer information includes a type of flow of which transfer to the second path is permitted or a type of flow of which transfer to the second path is prohibited.
